(19) United States
(12) Patent Application Publication
(10) Pub. No.: US 2014/0229204 A1
(43) Pub. Date: Aug. 14, 2014

(54) ESTIMATE METHOD AND GENERATOR

(71) Applicant: Symbility Solutions Inc., Toronto (CA)

(72) Inventors: Marc-Olivier Huynh, Montreal (CA); Kenneth C. Robinson, Wauwatosa, WI (US); Jonathan E. Kost, Waterford, WI (US); Guillaume Leonard, Montreal (CA)

(73) Assignee: Symbility Solutions Inc., Toronto (CA)

(21) Appl. No.: 14/176,755

(22) Filed: Feb. 10, 2014

Related U.S. Application Data
(60) Provisional application No. 61/762,827, filed on Feb. 8, 2013.

(51) Int. Cl. G06Q 30/06

(52) U.S. Cl. CPC G06Q 30/0611
USPC 705/4; 705/26.4

(57) ABSTRACT

A method and apparatus receive a graphic of the property, determine a characteristic of the property from the received graphic, modify a modifiable hierarchical scripted questionnaire based on the characteristic of the property determined based upon the received graphic, display the questionnaire as modified, based on the characteristic of the property determined from the received graphic and display an estimate pertaining to the property based on the graphic and the responses to the questionnaire.

### CROSS-REFERENCE TO RELATED PATENT APPLICATIONS

The present application claims priority under 35 USC 120 from co-pending U.S. Provisional Patent Application Ser. No. 61/762,827 filed on Feb. 8, 2013 by Huynh et al. and entitled ESTIMATE METHOD AND GENERATOR, the full disclosure of which is hereby incorporated by reference. The present application is related to co-pending application Ser. No. 13/952,339 filed on Jul. 26, 2013 by Robinson et al. and entitled CLAIMS-UNDERWRITING INTEGRATION SYSTEM AND METHOD, the full disclosure of which is hereby incorporated by reference.

### BACKGROUND

Various companies, such as insurance companies, field service companies, mitigation companies and the like often hire contractors to carry out the repair of a damaged property or the preservation of an acquired property. Estimates are typically prepared to identify the tasks to be completed and their associated costs. Current processes for generating such estimates, reviewing such estimates and managing repair and/or maintenance projects are difficult and time-consuming while producing estimates/bids that may be ambiguous, incomplete and inconsistent.

### BRIEF DESCRIPTION OF THE DRAWINGS

FIG. 1 is a schematic diagram of an example estimate generation system.

FIG. 2 is a flow diagram of an example method that may be carried out by the system of FIG. 1.

FIG. 3 is a diagram of an example interface screen presenting a portion of an example scripted questionnaire for generating an estimate.

FIGS. 4 and 5 are diagrams of example interface screens automatically presenting alternative branches of the scripted questionnaire in response to different input/responses.

FIG. 6 is a diagram of an example interface screen presenting a cost estimate automatically generated in response to completed portions of the scripted questionnaire.

FIG. 7 is a diagram of an example interface screen presenting another portion of the example scripted questionnaire.

FIG. 8 is a diagram of an example interface screen presenting the scripted questionnaire with the automatic addition of questions in response to user responses to the scripted questionnaire.

FIG. 9 is a diagram of the example interface screen of FIG. 8 presenting issue questionnaire with the automatic addition of additional questions in response to the questions added in FIG. 8.

FIG. 10 is a diagram of an example interface screen automatically presenting an alternative branch of the scripted questionnaire in response to a different user response to the scripted questionnaire presented in FIG. 8.

FIG. 11 is a diagram of an example interface screen for importing externally sourced graphics.

FIG. 12 is a diagram of an example interface screen depicting an imported graphic.

FIG. 13 is a diagram of an example interface screen presenting a portion of the questionnaire requesting identification of the imported graphic.

FIG. 14 is a diagram of an example interface screen in which the user may request that the imported graphic be used to calculate a building footprint.

FIG. 15 is a diagram of an example interface screen illustrating the automatic pre-filling or completion of the questionnaire utilizing the building footprint (square footage) information of the building calculated from the imported graphic.

FIG. 16 a diagram of another example cost estimation system.

FIG. 17 is a flow diagram of an example method that may be carried out by the system of FIG. 16.

FIG. 18 is a flow diagram of an example implementation of the method of FIG. 16.

FIG. 19 is a flow diagram of the method of FIG. 17, highlighting steps carried out by the example interface screens of FIGS. 20-23.

FIG. 20 is a diagram of an example interface screen presenting file information for property.

FIG. 21 is a diagram of an example interface screen presenting the creation of a new file for an assigned property.

FIG. 22 is a diagram of an example interface screen illustrating the automatic pre-filling of property data.

FIG. 23 is a diagram of an example interface screen for the assignment of contractors.

FIG. 24 is a flow diagram of an example contractor workflow.

FIG. 25 is a diagram of an example interface screen identifying properties or jobs that have been assigned to a field service contractor.

FIG. 26 is a diagram of an example interface screen listing assigned properties and crew assignment status for each property.

FIG. 27 is a diagram of an example interface screen to facilitate the assignment of crewmembers to particular jobs.

FIG. 28 is a diagram of an example interface screen for providing a map route for different jobs for a crew.

FIG. 29 is a diagram of an example interface screen providing a field service crew with information regarding a job, including prefilled information.

FIG. 30 is a diagram of an example interface screen providing a field crew member with a hierarchal modifiable scripted questionnaire during inspection.

FIG. 31 is a diagram of an example interface screen prompting a crew member to input additional information based upon input provided to the questionnaire shown in FIG. 30.

FIG. 32 is a diagram of an example interface screen providing the crew member with a route map for the next stop once a prior property inspection has been completed.

FIG. 33 is a diagram of an example interface screen prompting and guiding a working crew through tasks of a bid job to be executed.

FIG. 34 is a flow diagram of an example method for completing a contractor bid for the method of FIG. 17.

FIG. 35 is a diagram of an example interface screen presenting information generated based upon field crew input and review of the bid.

FIG. 36 is a diagram of an example interface screen presenting the bid or estimate as a whole for review.

FIG. 37 is a flow diagram of an example implementation of a bid review process of the method of FIG. 17.

FIG. 38 is a diagram of an example interface screen identifying a status of properties with respect to field service contractors.

FIG. 39 is a diagram of an example interface screen presenting retrieved independently researched cost estimates for each line item presented in the field service contractor bid.

FIG. 40 is a diagram of an example interface screen providing a comparison of the field service contractor bid line item cost estimates with respect to independently researched line item cost estimates.

FIG. 41 is a diagram of an example interface screen facilitating review of inspection photos taken by a field service group to verify the need for various line item tasks.

FIG. 42 is a diagram of an example interface screen presenting menu items for approval or rejection by field service company.

FIG. 43 is a diagram of an example interface screen prompting for input regarding reasons for a rejection.

FIG. 44 is a diagram of an example interface screen facilitating creation of comparative bids

FIG. 45 is a diagram of an example interface screen establishing notification protocols.

### DETAILED DESCRIPTION OF THE EXAMPLE EMBODIMENTS

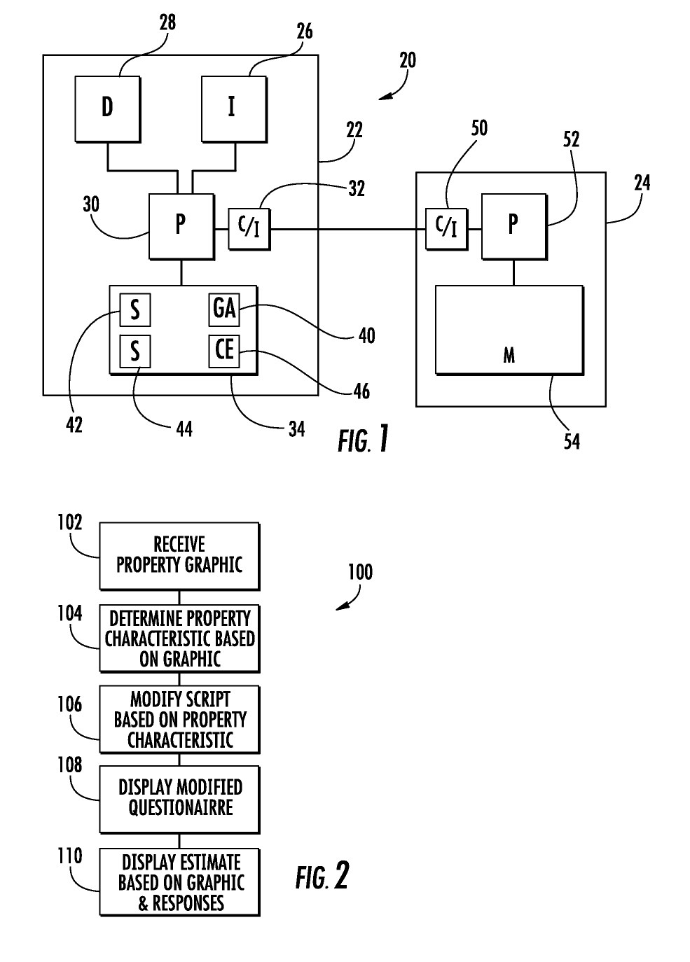

FIG. 1 schematically illustrates an example estimate generation system 20. Estimate generation system 20 generates an estimate pertaining to property. The estimate may be a cost estimate for repairing the property. The estimate may alternatively or additionally comprise a cost estimate for performing steps to maintain the property such as with an occupied building. As will be described hereafter, estimate generation system 20 provides a structured mechanism for determining such an estimate and enhancing estimate reliability and consistency.

As shown by FIG. 1, estimate generation system 20 comprises estimate generator 22 and remote data facility 24. Generator 22 generates an estimate. Generator 22 comprises input 26, display 28, processor 30, communication interface 32 and memory 34. Input 26 comprises one or more devices by which data and/or graphics may be input or otherwise provided to generator 22. Examples of input 26 include, but are not limited to, a keyboard, a touchpad, a touchscreen, a keypad, a stylus, a microphone, speech recognition software and the like.

Display 28 comprises one or more devices to present information to a person using generator 22. Display 28 may comprise a monitor or screen. In one implementation, display 28 may comprise a touchscreen, also serving as input 26.

Processor 30 comprises one or more processing units to follow instructions contained in memory 34 so as to output a cost estimate for at least one property. For the purposes of this application, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, processor 30 may be embodied as part of one or more application-specific integrated circuits (ASICs). Unless specifically noted otherwise, the controller is not limited to any specific combination of hardware circuitry and software, nor to any particular source for the instructions executed by the processing unit.

Communication interface 32 comprises a device facilitating communication between processor 30 of generator 22 and remote data facility 24. In one implementation, communication interface 32 comprises a device to facilitate wireless communication across a wide area network, such as the Internet. Another implementation, communication interface 32, may facilitate the wired communication. In yet other implementations, communication interface 32 may comprise a port to receive a portable memory device onto which data or programs may be transferred. In some implementations, communication interface 32 may be omitted.

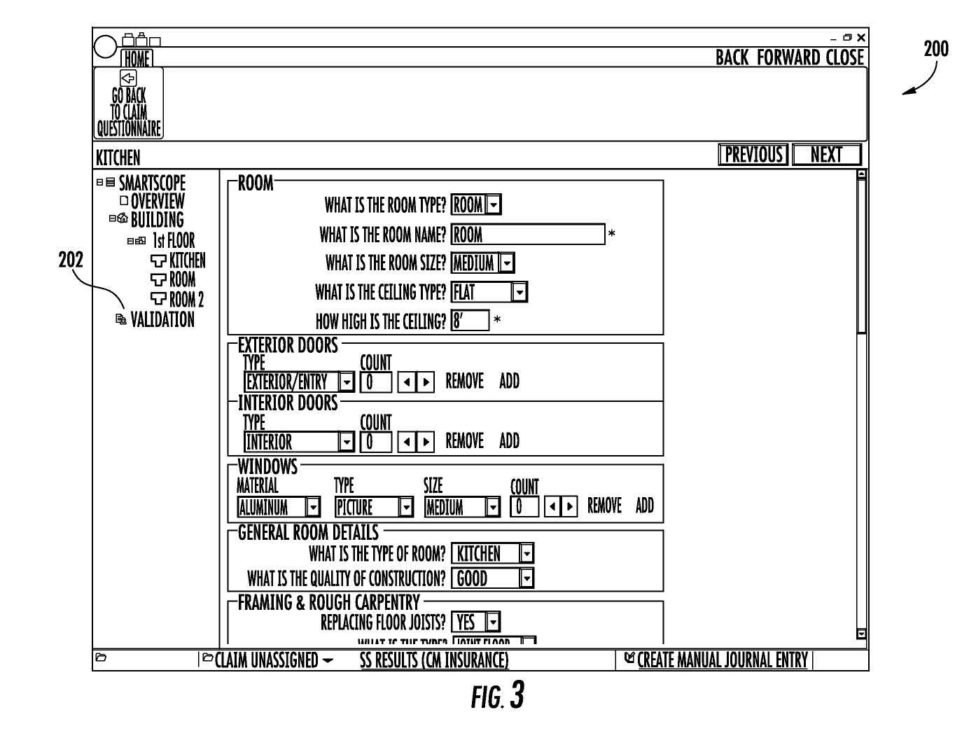

Memory 34 comprises a non-transient computer-readable medium containing software, code or programming and instructs the operation of processor 30. As noted above, memory 34 may comprise a mass storage device, or some other persistent storage. Memory 34 comprises graphic analyzer module 40, script module 42, database 44 and cost estimator module 46. Graphic analyzer module 40, script module 42 and cost estimator module 46 comprise software modules or programming units which cooperate with one another to instruct processor 30 in carrying out method 100 shown in FIG. 2. Database 44 contains data used by processor 30 to output a cost estimate. Database 44 may be further utilized to store responses as well as determined cost estimates.

Cost estimator module 46 instructs processor 32 to determine a cost estimate for a piece of property utilizing one or both of (a) responses to questions posed by script module 42 and (b) data obtained from graphics pursuant to instructions provided by graphic analyzer 40.

In one implementation, estimate generator 22 comprises a portable electronic device. Examples of such a portable electronic device include, but are not limited to, a smart phone, a personal data assistant, a computer tablet, a computer notebook and the like. As a result, estimate generator 22 may be portably carried to a building or other property for which an estimate is to be generated. In other implementations, estimate generator 22 may be provided on a desktop or other more stationary computing devices.

Remote data facility 24 comprises a remote facility in communication with estimate generator 22. Remote data facility 24 receives the cost estimate output by generator 22. In one implementation, remote data facility 24 additionally transmits data and/or programming to generator 22. Remote data facility 24 comprises communication interface 50, processor 52 and memory 54.

Communication interface 50 comprises a device facilitating communication between processor 52 of facility 24 and generator 22. In one implementation, communication interface 50 comprises a device to facilitate wireless communication across a wide area network, such as the Internet. In another implementation, communication interface 50 may facilitate wired communication. In yet other implementations, communication interface 50 may comprise a port to receive a portable memory device onto which data or programs may be transferred. In some implementations, communication interface 50 may be omitted.

Processor 52 comprises one or more processing units to regulate the transmission of data and/or programs or programming modifications between facility 24 and generator 22. Memory 54 comprises a non-transient computer-readable medium or persistent storage device for storing cost estimates received from generator 22. In one implementation, memory 54 further stores responses received by generator 22 through input 26 and transmitted to facility 24. In one implementation, memory 54 further comprises data for use by processor 30 in determining cost estimates. In still other implementations, memory 34 may also comprise programming, programming updates or modifications which may be transmitted to generator 22. For example, in some implementations, script module 42 and/or graphic analyzer module 40 may be omitted from memory 34, wherein such models are stored in memory 54 and wherein such instructions for processor 30 are transmitted using communication interfaces 50 and 32. In one implementation, remote data facility 24 comprises an insurance entity. In other implementations, remote data facility 24 may comprise other vanities remote from generator 22.

FIG. 2 is a flow diagram of an example method 100 which may be carried out by estimate generation system 20 shown in FIG. 1. As indicated by step 102, generator 22 receives the property graphic. In particular, graphic analyzer module 40 instructs processor 32 to prompt a person for the input of a graphic of at least a portion of the property for which a cost estimate is to be generated. The property graphic may comprise a diagram, a captured image or the like. In one implementation, the property graphic is received through communication interface 32 from a remote source. For example, in one implementation, the received graphic may comprise a floor diagram or an overhead image of the building received from a remote source. In one implementation, the image may be provided by an aerial photograph of the like. In another implementation, the property graphic is received through input 26. For example, in one implementation, the property graphic may comprise a floor diagram created by user using input 26.

As indicated by step 104, processor 30, following the instructions containing graphic analyzer 40, analyzes the graphic to determine one or more characteristics of the property. For example, in circumstances where the graphic comprises a floor diagram, processor 30 may determine the presence of an island in a kitchen, the number of doors in a room, the number of windows or the size of such windows in a room, the area of floor in a room, the estimated footprint of cabinetry in a room and the like. In implementations where the graphic comprises a roof plan, processor 30 may determine a footprint of the building, an estimated number of rooms, an estimated size of rooms, a roof type and the like.

As indicated by step 106, processor 30, following instructions contained in script module 42, modifies a modifiable hierarchical scripted questionnaire based on the characteristic of the property determined using the received graphic. For example, in one implementation, in situations where the analysis of the graphic identifies the footprint of the building, processor 30 may remove questions pertaining to the square footage of the building from the script or questionnaire. Likewise, in situations where the analysis of the graphic identifies the number of doors in a room or the dimensions of a room, processor 30 may remove questions pertaining to the number of doors or dimensions of the room or questions pertaining to cabinetry dimensions.

In some implementations, processor 30 does not remove questions based upon the analysis of the graphic, but instead presents or displays particular questions along with prefilled or completed answers, wherein the prefilled or completed answers are automatically completed by processor 30 based upon the analysis of the graphic. For example, the scripted questionnaire may include a question regarding the number of doors in a room. Processor 30, using the analysis of the graphic, may already have determined that the particular room has two doors. In such a circumstance, processor 30 may cause display 28 to present the question regarding the number of doors in the room and may also present the automatically completed answer indicating that two doors are present. As a result, the person is allowed to view the question and the automatically completed response. The person is also allowed to see what factors go into the cost estimate. In one implementation, processor 30 may either prompt the person to confirm the automatically completed answer to the question or may allow the person to override the automatically completed answer with an input answer. As a result, the person has the opportunity to correct errors resulting from the analysis of the input graphic.

In addition to removing questions or automatically completing or pre-filling answers to questions, processor 30 may also follow a different branch or line of questions based upon the property characteristics determined from analysis of the graphic. In some circumstances, processor 30 may alter or modify the scripted questionnaire based upon both responses to the scripted questionnaire, as well as the property characteristics determined from the analyze graphic. For purposes of this disclosure, the action of modifying the scripted questionnaire means those portions of a questionnaire that are presented to a person for response. For purposes of this disclosure, the action of modifying a questionnaire comprises modifying or altering which portion of the stored questionnaire is presented, altering the path or line of questioning through the various branches of the logic tree of the questionnaire or modifying the logic tree itself.

As indicated by step 108, processor 30, following instructions contained in script module 42, displays the modified questionnaire on display 28. In particular, processor 30 prompts for the input of one or more responses to the questionnaire by the person. In one implementation, processor 30, following instructions contained in script module 42, additionally prompts for the capture and input of photographs evidencing or depicting visible proof corroborating answers input to one or more questions of the questionnaire. Such photographs may be digitally captured by a person's mobile device, such as a smart phone, tablet computer or other portable image capturing device. In one implementation, the photographs that are captured are automatically stored and linked to the individual questions to which they are associated. In one implementation, the photographs that are captured are automatically uploaded to remote data facility 24 along with the input responses. In one implementation, processor 30 may additionally provide a person with an opportunity to supplement his or her answers to a question with comments. In one implementation, in addition to presenting such questions, processor 30 may present guidance or tips to assist the person answering the questionnaire to improve accuracy and avoid incorrect responses to the questionnaire.

As indicated by step 110, processor 30, following instructions provided by cost estimator module 46, utilizes such responses and data obtained from the analysis of the input graphic to determine a cost estimate. As further indicated by step 110, processor 30 displays the cost estimate on display 28. In some implementations, the cost estimate may additionally be transmitted to remote data facility 24 for storage in memory 54 and/or for display at remote facility 24.

In the example illustrated, the one or more persons prompted to complete the scripted questionnaire comprise end-users of the cost estimation system. Such end-users may comprise field contractors, such as subcontractors, government employees or agents such as inspectors, or boarders (to board up empty homes), financial institutions such as when a home is foreclosed or with respect to a portfolio of bank owned homes, nonprofits such as with respect to re-fab homes and/or property managers such as rental property managers or real estate owned (REO) property—a class of property owned by a lender such as a bank, government agency or government loan insurer after an unsuccessful sale at a foreclosure auction.

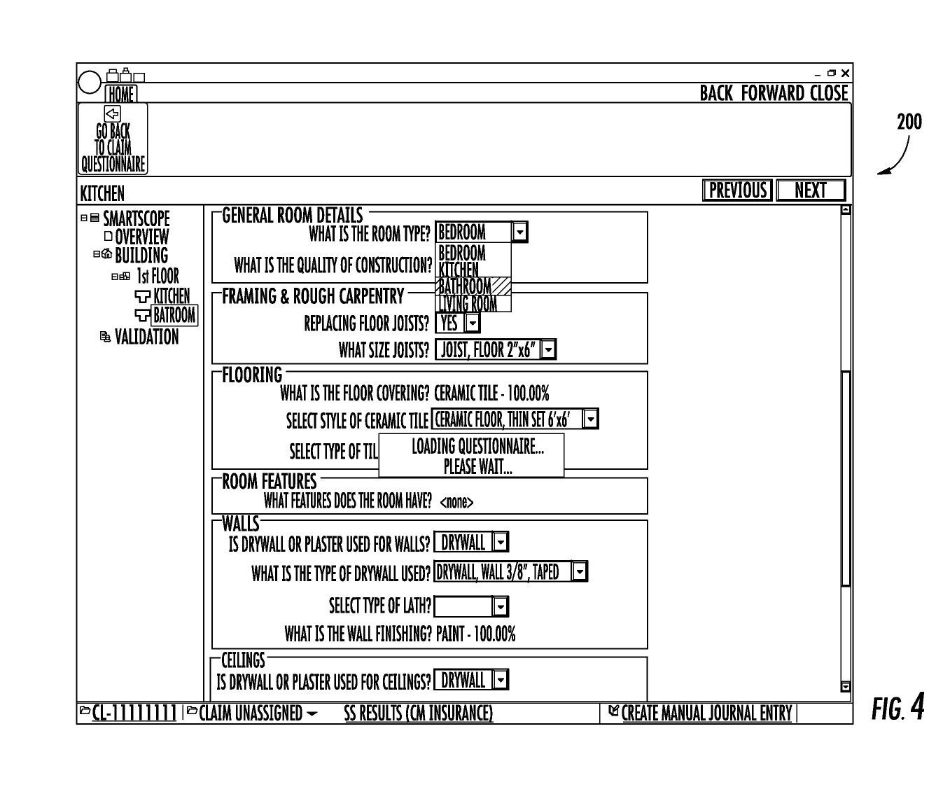

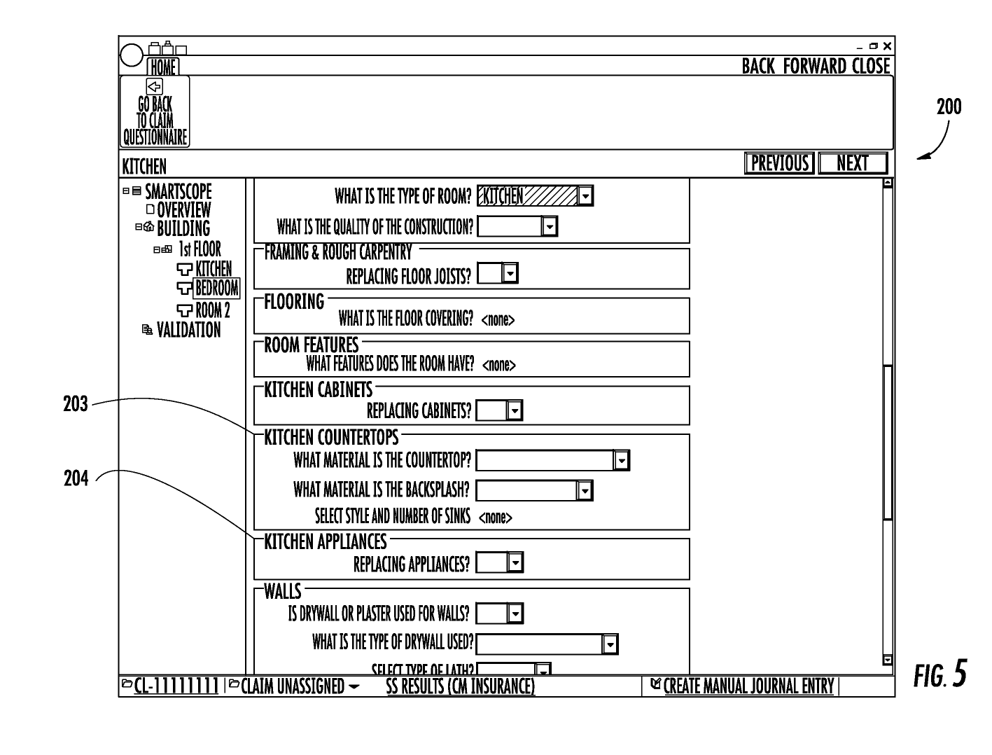

FIGS. 3-15 illustrate one example implementation of method 100 as carried out by system 20. FIGS. 3-9 illustrate an example modifiable hierarchical scripted questionnaire 200. Questionnaire 200 facilitates a collection of information about a property and property damage to create a repair estimate. Questionnaire 200 is launched from within a claim file, wherein users see screens that include questions that are driven by an underlying decision tree that guides the estimation process. In the example shown by FIG. 3, a user is prompted by the scripted questionnaire 200 to input information about a room of the building for which a repair estimate is to be generated. As a person progresses through the questionnaire to define rooms, a tree 202 is modified to reflect such progress. FIGS. 4 and 5 illustrate how selections made in the “general room details” in FIG. 3 result in the hierarchical scripted questionnaire being modified. FIG. 4 illustrates the operation of script 200 during which the user inputs that the type of room is a bathroom. By way of contrast, FIG. 5 illustrates the operation of script 200 during which user inputs of the type of room is a kitchen. As a result, the script being presented in FIG. 5 is modified to prompt for inputs specifically pertaining to kitchens such as prompts 203 kitchen countertops and prompts 204 for kitchen appliances.

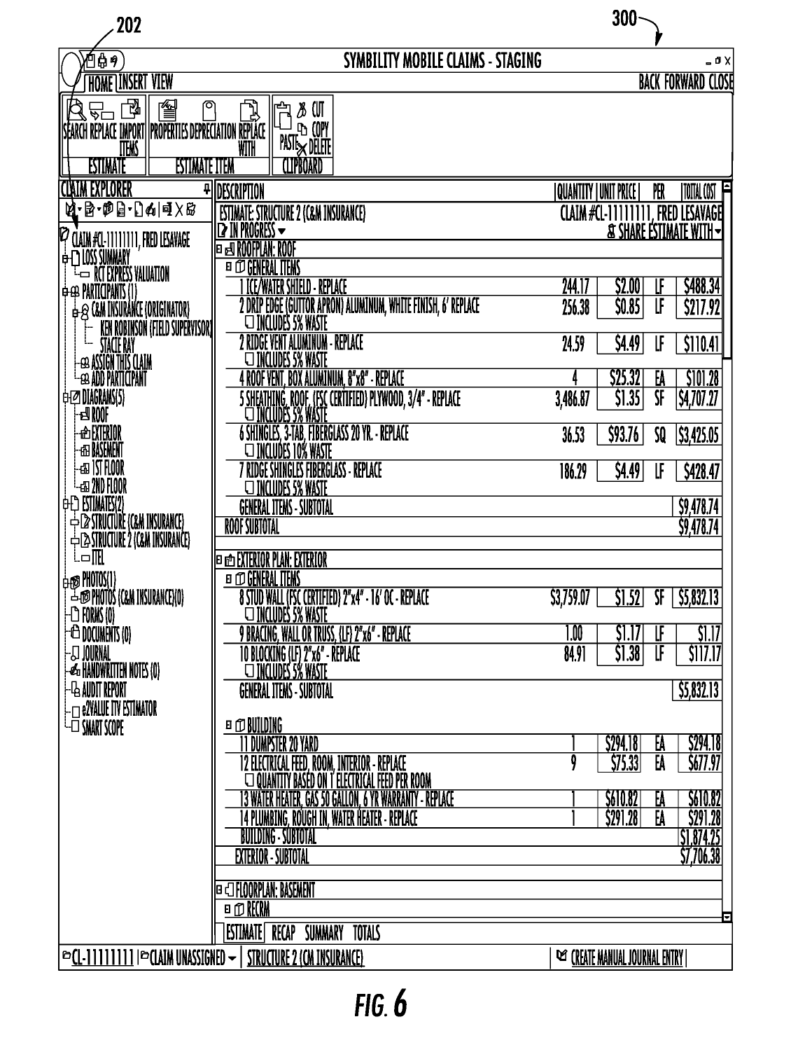

As shown by FIG. 6, once the required questions have been responded to, the user may click a “generate” button on the displayed screen to produce an estimate 300 on a line-by-line item basis. Estimate 300 provides an itemized list of individual tasks for different portions of the property and the associated costs. As shown by tree 202 on the left side of the displayed screen, the estimation process is continually tracked. As shown by tree 202, the particular line estimate 300 is provided for the exterior of the property. Additional estimates have been prepared for other portions such as the roof, basement, first floor and second floor. As further shown by tree 202, additional documentation is further prompted for by processor 30 and input by the user as part of the estimation process. Such documentation includes forms, documents, photos, journal entries, handwritten notes and the like. Tree 202 allows a person to jump between different data files or display screens.

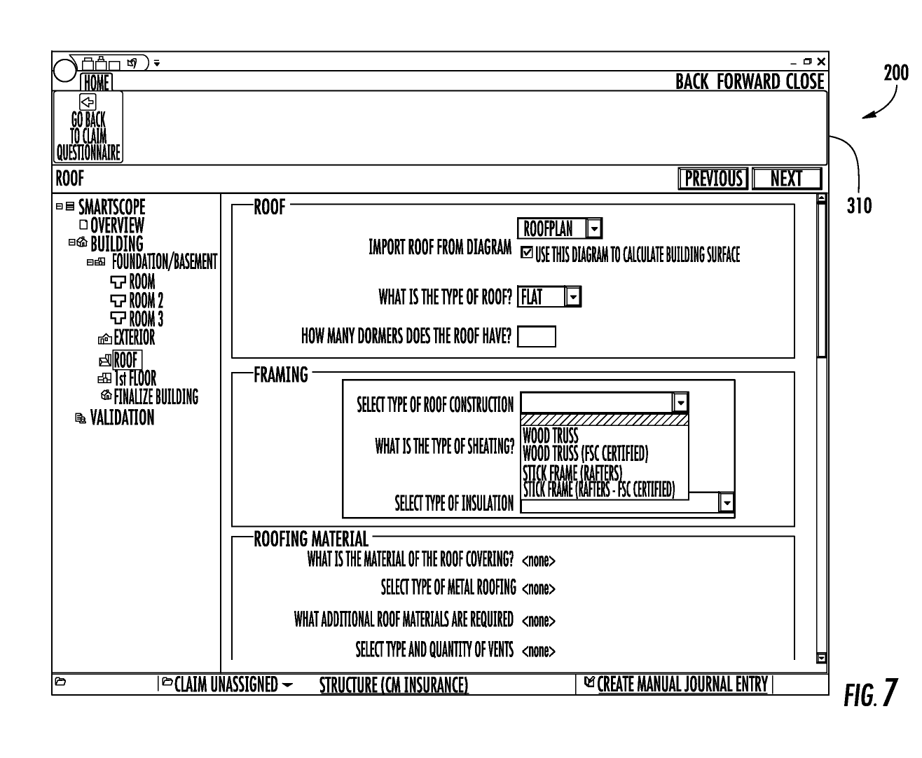

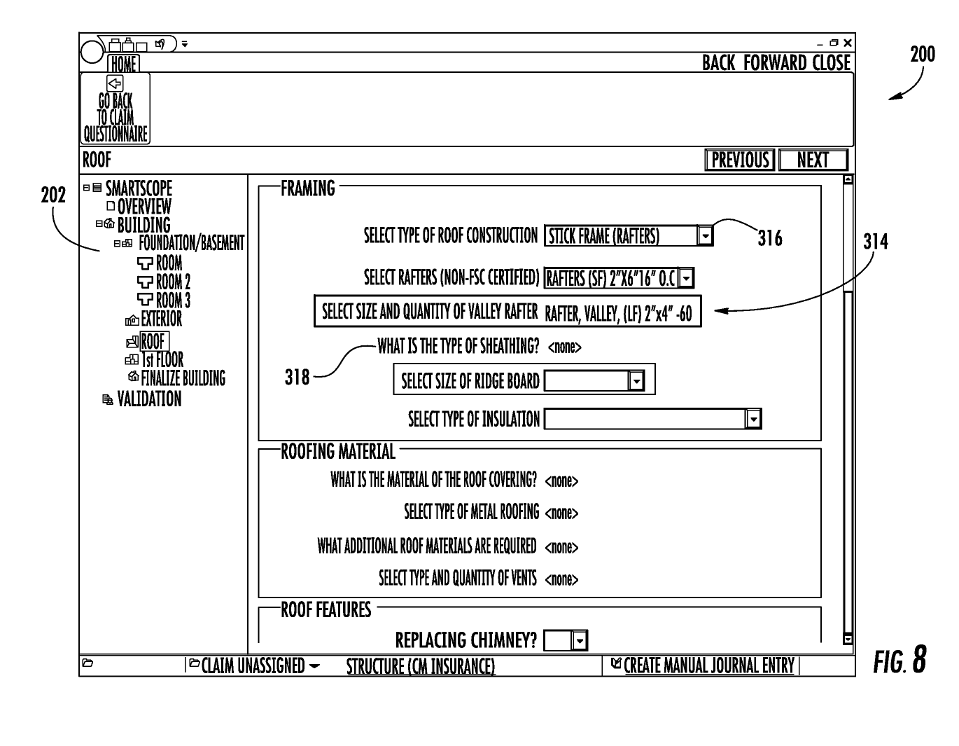

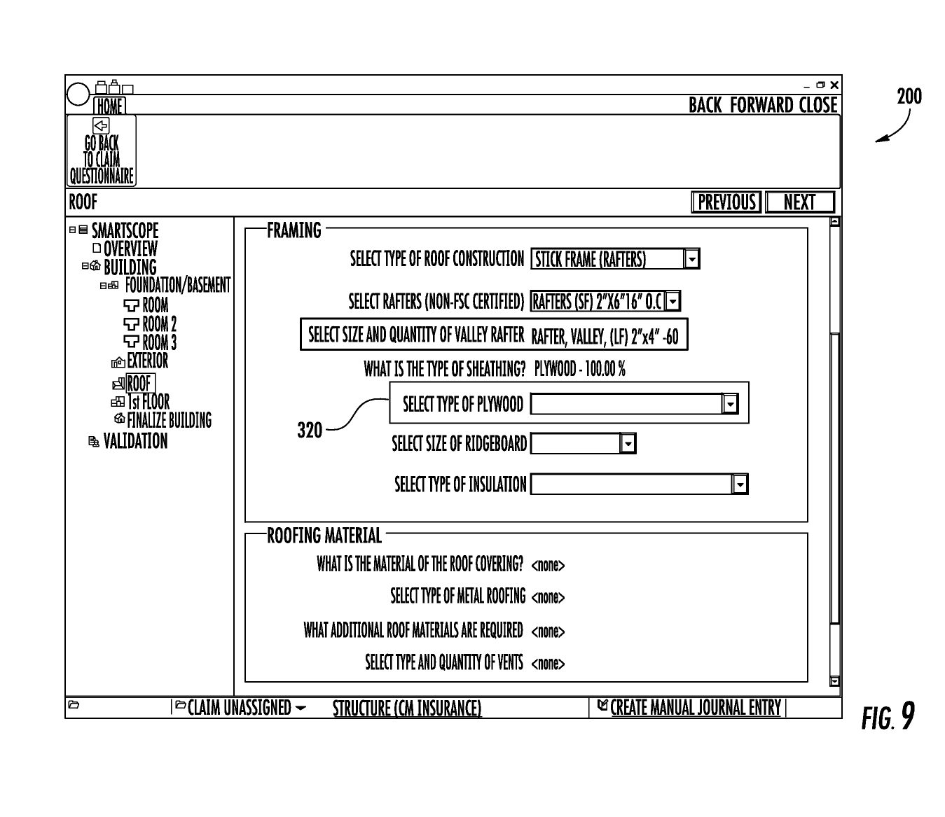

FIG. 7 illustrates the roof page 310 of the questionnaire 200, wherein the user is prompted by processor 30 to input information pertaining to the type of roof construction. FIG. 8 illustrates the addition of questions to questionnaire 200 based upon prior responses to questionnaire 200. FIG. 8 illustrates a portion 314 of the scripted questionnaire 200 that is added to the script being presented when “stick frame” 316 is selected for the roof type. In response to the input “stick frame” 316 for roof type, new questions 316 are added regarding the size or quantity of rafters and the size of the ridge board used. FIG. 9 illustrates how the logic tree or the modifiable script 200 is modified in response to “plywood” being selected as the type of sheathing in response to question 318 shown in FIG. 8. As shown by FIG. 9, processor 30 adds an additional question 320 with regard to the type of plywood.

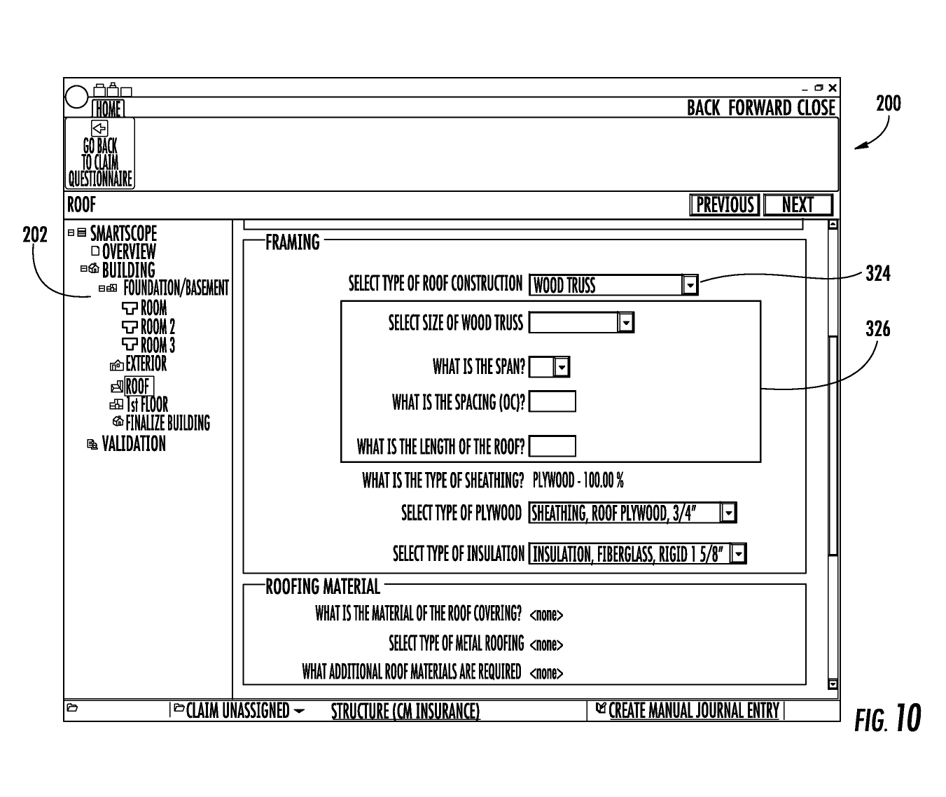

FIG. 10 illustrates a portion of the script being presented in response to the type of roof construction being identified as “wood truss” 324. In contrast to FIG. 8 in which the roof construction was input as “stick frame” and in which a first set of specific questions was presented, FIG. 10 illustrates a completely different second set of specific questions 326 that are presented when “wood truss” is input as the type of roof construction.

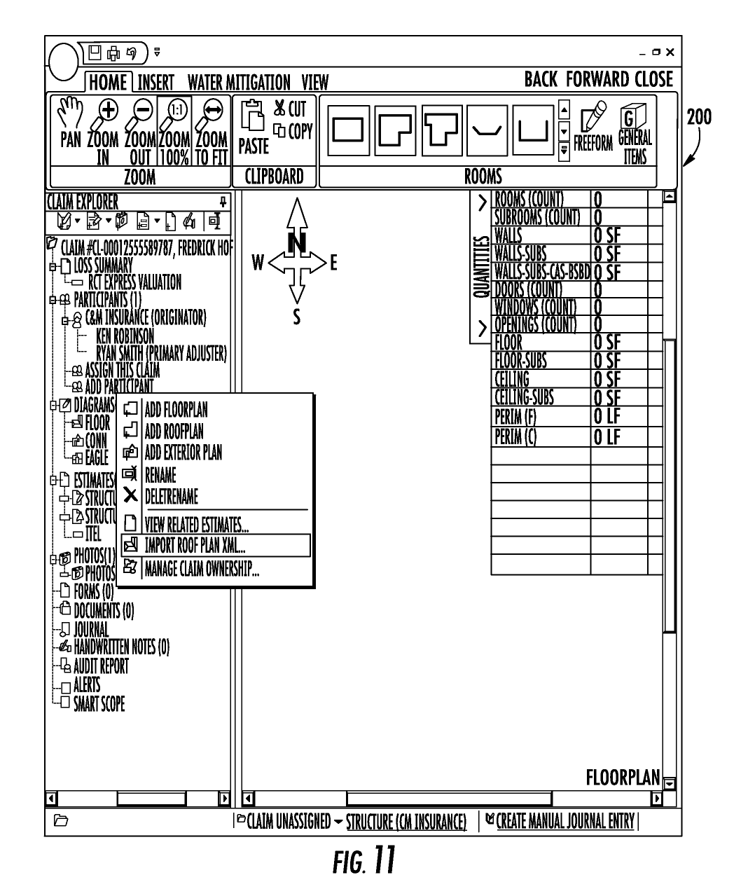

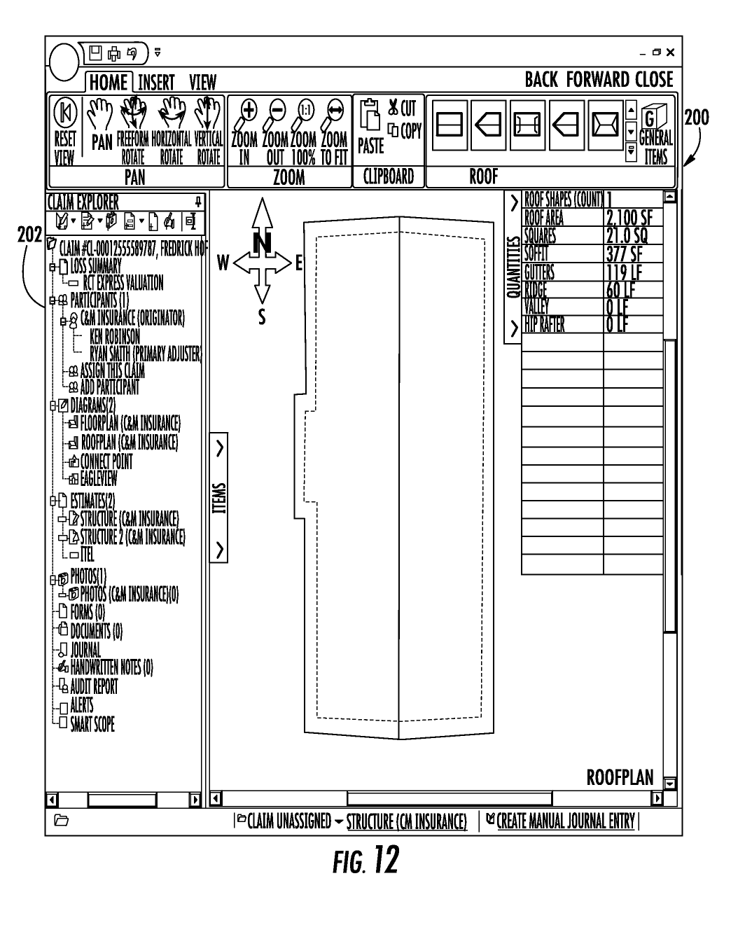

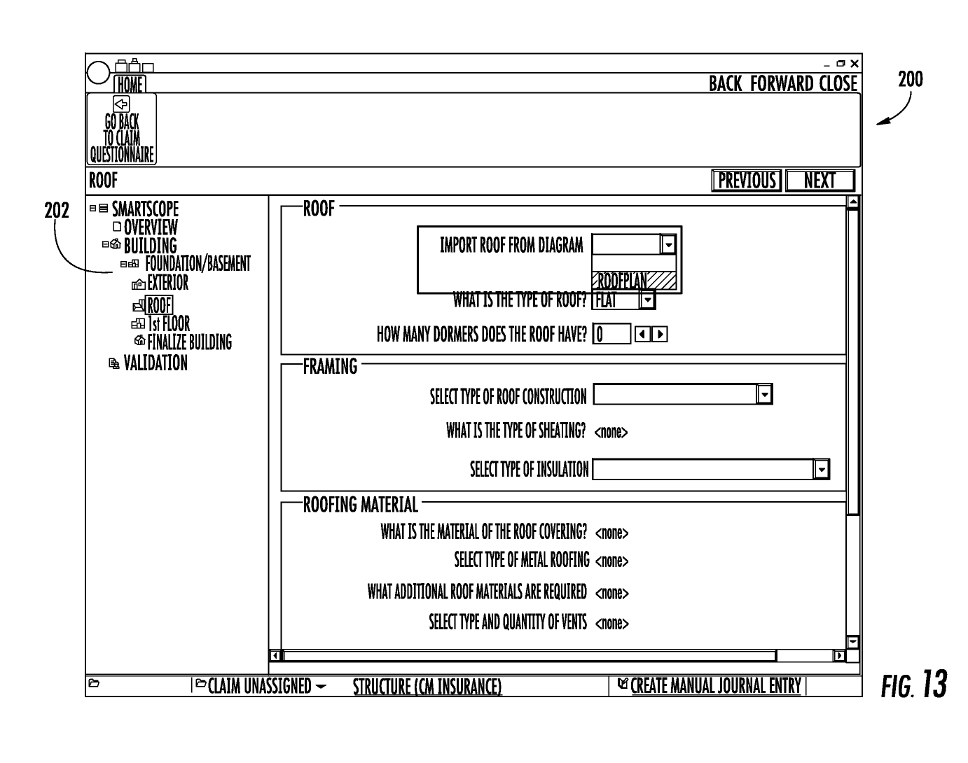

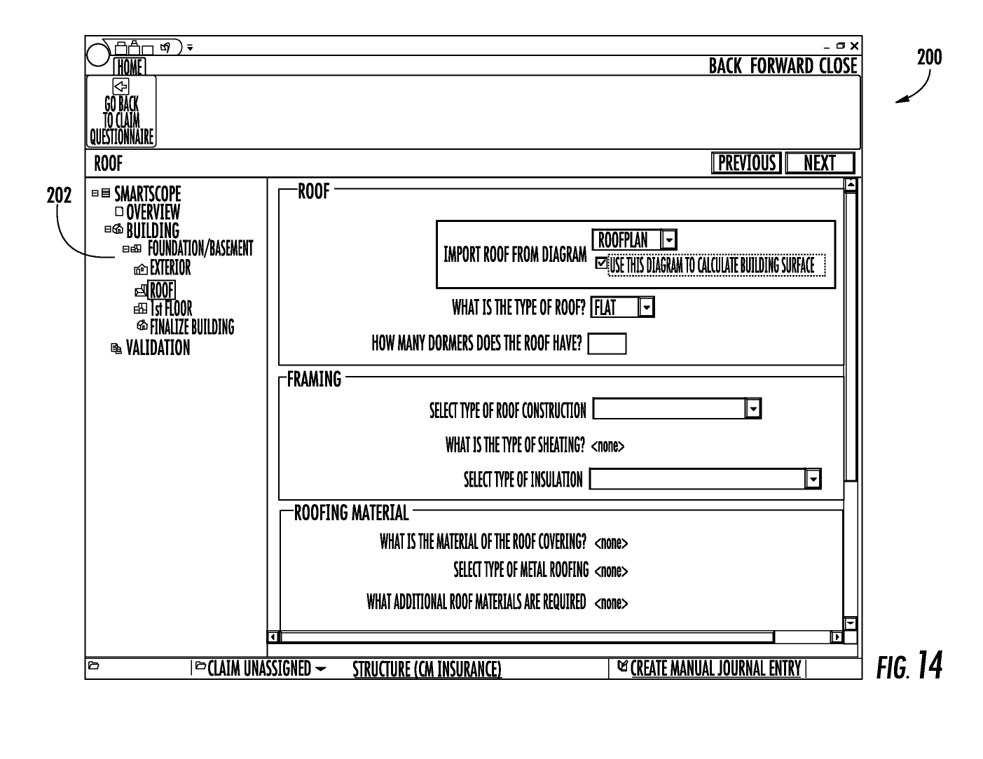

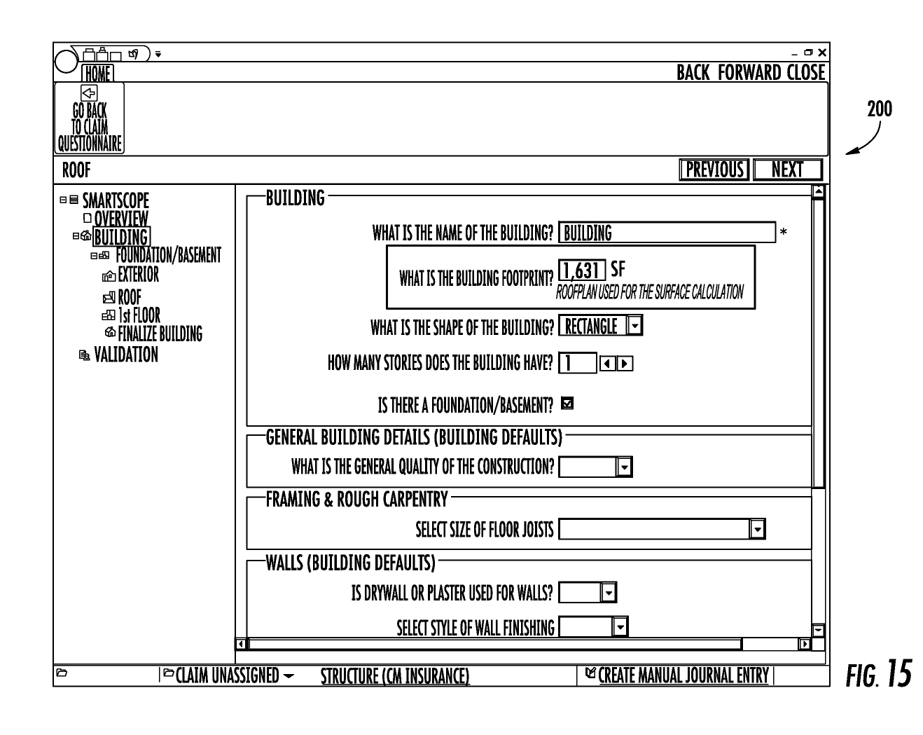

FIGS. 11-15 illustrate modification of the script based upon a received graphic of the property. In the example illustrated, system 20 is leveraging an imported 3-D model. In particular, the overhead 3-D modeling information obtained from the 3-D overhead model is used to define the footprint underneath it. FIG. 11 illustrates a portion of questionnaire 200 which facilitates the importation of an aerial image, photograph or report (e.g., such as a report from an aerial image provider n XML format). FIG. 12 illustrates questionnaire 200 depicting the roof information that was imported. FIG. 13 illustrates questionnaire 200 requesting confirmation from the user regarding use of the imported roof diagram to generate responses to the questionnaire and/or automatically edit/modify the potential questionnaire. For example, as shown by FIG. 14, the user may choose to use a diagram to calculate the building footprint or to calculate a building surface. Lastly, as shown by the portion of questionnaire 200 shown in FIG. 15, the user may also instruct that system 22 utilize or leverage the roof plan to estimate a square footage of the building footprint. In some implementations, system 20 may further utilize the size and shape of the imported roof plan to determine a number of rooms and the size of such rooms. In such circumstances, the modifiable scripted questionnaire automatically omits specific questions pertaining to room size and room number or may simply request confirmation of the estimated number of rooms or size of such rooms.

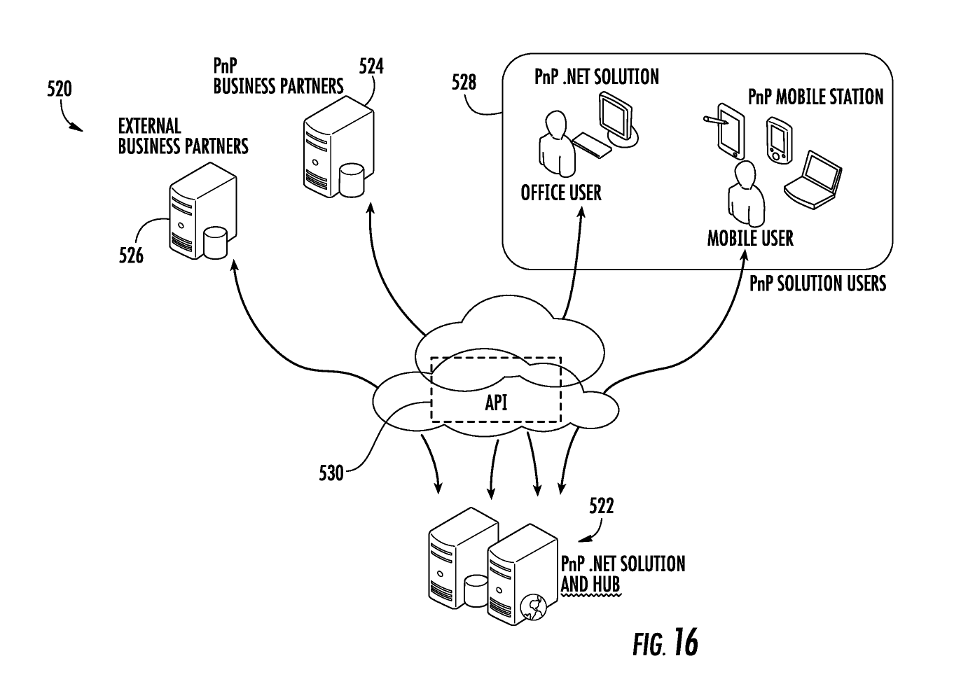

FIGS. 16-26 illustrate cost estimation system 520. Cost estimation system 520 outputs a cost estimate for a building (either occupied or unoccupied). In particular, system 520 outputs maintenance steps for the unoccupied building based upon responses to a modifiable hierarchical scripted questionnaire regarding characteristics of an unoccupied building. Based upon responses to questions from the questionnaire, different portions of the scripted questionnaire are presented. In other words, different branches of a logic tree or hierarchical questionnaire may be presented while others may not be presented. As a result, system 520 provides a structured foundation to ensure that cost estimates are based upon a more complete, comprehensive set of inputs to ensure that the resulting cost estimates are also more consistent and reliable.

As shown by FIG. 16, system 520 generally comprises a hub 522, partners 524, 526 and users 528. Hub 522 comprises one or more servers in communication with a wide area network such as the Internet. Such servers include one or more processors following instructions contained in one or more non-transient computer-readable mediums in the form of programming to establish an application program interface (API) 530. Interface 530 comprises a program by which partners 524, 526 and users 528 may access and interact with in order to proceed through a cost estimation and bid process for inspecting, repairing and/or maintaining properties a real state, such as unoccupied properties.

Partners 524, 526 comprise entities outside of the service entity providing hub 522. For example, such partners 524, 526 may comprise property and preservation (PnP) business partners of the service entity providing hub 522 or may comprise external business partners of the service entity providing hub 522. By way of example, property and preservation business partners may comprise sources of data for estimating, such as governmental organizations, private data sources and the like. A provider of overhead aerial photography or satellite imagery for providing roof graphics artist photographs is one example of a private data source. External business partners may comprise suppliers of equipment or materials for preserving or repairing property which have partnered with the service entity providing hub 522, wherein users of system 520 may access or utilize normalized or negotiated pricing for such materials, goods or services. External business partners may also comprise companies in the insurance space (e.g., insurance carriers, agents, adjusters, valuation companies, data companies, etc.)

Users 528 comprise entities more directly involved in the estimation process, whether they be located at an office using stationary communication devices, such as desktops, or whether they be more mobile in nature, utilizing laptops, smartphones, personal data assistants and the like. In one implementation, users 528 comprise one or more of an asset/property owner, a field service company/real estate broker and a field service contractor (including both managers and field crew). The asset/property owner comprise the entity which has a property requiring repair and/or preservation activities. The field service company/real estate broker may be the entity responsible for the upkeep of the property. The field service contractor comprises an entity contractible by the field service company/real estate broker to carry out such repair and/or preservation activities.

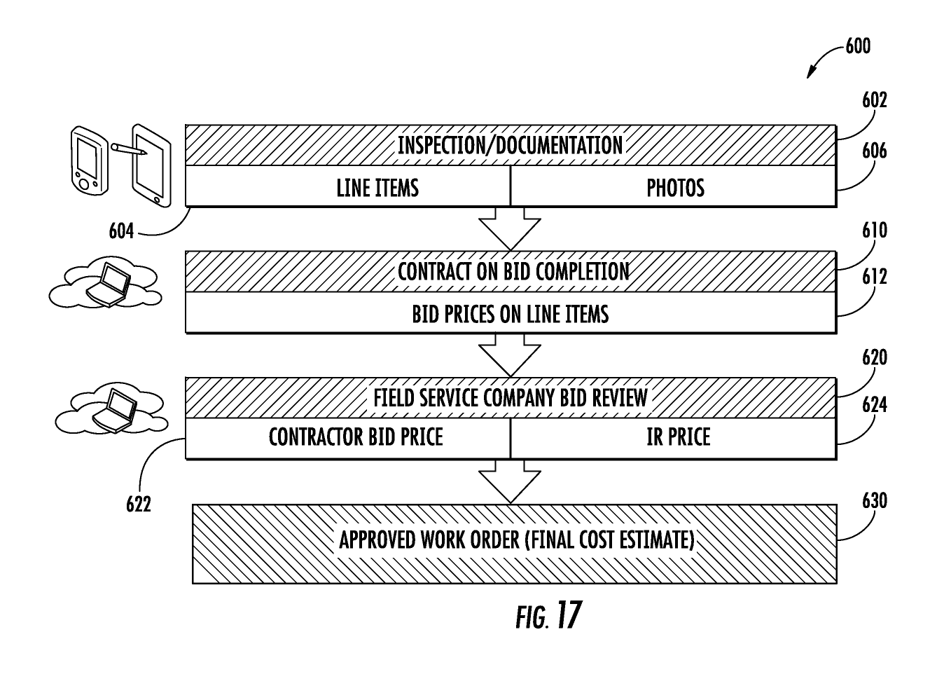

FIG. 17 illustrates one example implementation of an estimation method or process 600 that may be provided by interface 530 (shown in FIG. 16). As indicated by step 602 of FIG. 17, main components of process 600 comprise the inspection and documentation 602 of an asset. Such inspection and such documentation may include the gathering of information for line items 604 and photos 606. Line items 604 comprise overall tasks or groups of tasks having an individually assigned cost estimate. Each line item 604 may involve several action items or tasks. Interface 530 prompts field crew to input data or responses on a portable electronic device to questions regarding the property being inspected. In one implementation, a contractor field crew using a mobile device at the property may access interface 530 view the wide area network or “cloud” to access a predefined modifiable hierarchical scripted questionnaire. Based upon inputs to the questionnaire, the questionnaire script automatically changes or modifies the only present those questions required or most relevant. In one implementation, the scripted, yet modifiable, questionnaire gathers particular input from the field crew in accordance with foundational data required for an independently researched line item estimate. In particular, standard independently researched estimates for particular action items or line items contained at either hub 522 or other data sources such as partners 524, 526 may be based upon certain particular foundational pieces of information or may be based upon an presumption that a predefined set of tasks will be carried out. Because interface 530 forces each and every inspection through a standardized scripted questionnaire, each and every inspection/documentation step 602 carried out is guaranteed to obtain all of the proper information in the field (on-site at the property) for ensuring that the bid for a particular action item generated based upon the information gathered in the field can be accurately and appropriately compared to the independently researched estimate for the same line item.

Photos 606 comprise photos taken by the field crew at the property being inspected to provide systematic verification of the data provided as part of the input line items 604.

As indicated by block or step 610, based upon the responses or line item 604 as confirmed by the photos 606, a bid by the field service contractor is generated. The bid includes prices 612 for individual line items corresponding to line items for which independent researched estimates are available.

As indicated by block or step 620, the field service company or real estate broker reviews the bid received from the field service contractor. This review may entail a comparison of the bid price received from the field service contractor 622 to the corresponding independently researched price estimate 624. Such comparison may be made on a line item by line item basis, wherein the bid may be rejected as a whole or wherein individual line items in the contractor bid 622 may be rejected in response to nonconformity or irregularity with respect to the independently researched price estimate 624.

As indicated by step or block 630, approval of the particular bid results in an approved work order which is then communicated from the service company/real estate broker to the field service contractor(s). The entire process 600 depicted in FIG. 17 may be carried out through interface 530, driven by programming on hub 522 of the overall estimating service provider.

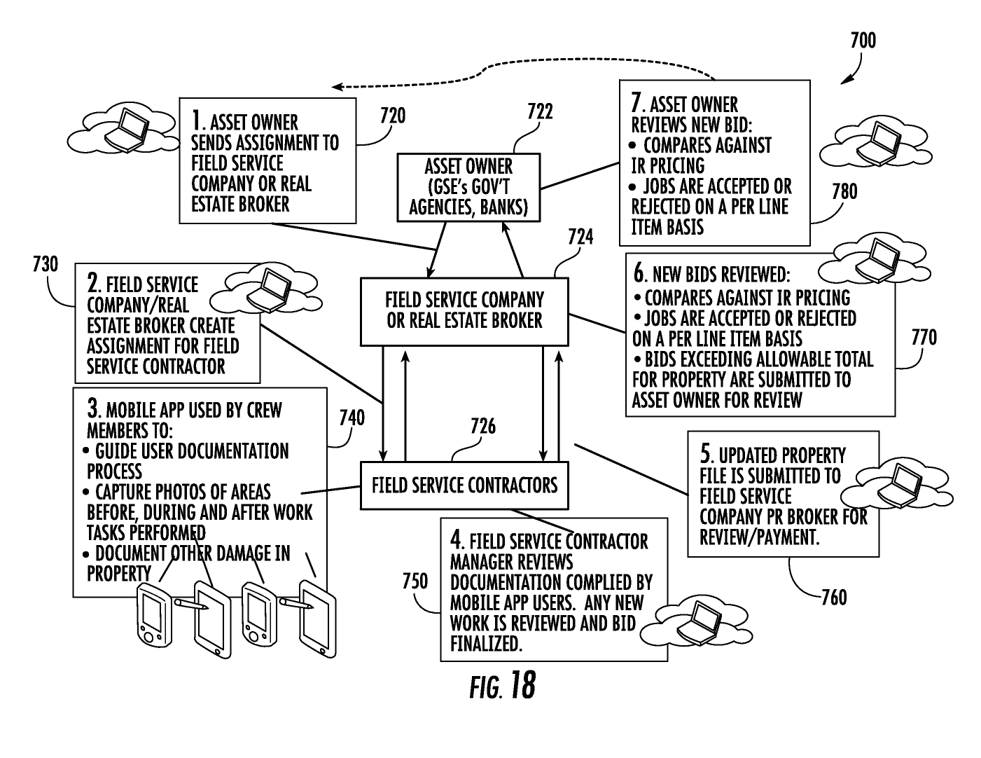

FIG. 18 is a flow diagram illustrating a method 700, one example implementation of estimation process 600. As shown by step 720, the asset owner 722 sends an assignment to the field service company/real estate broker 724. As indicated by step 730, the field service company/real estate broker 724 creates an assignment for the field service contractor 726. As indicated by step 740, field service crew of the field service contractor 726 use mobile applications (provided by interface 530 shown in FIG. 16) to guide the documentation process (line items 604 as described above) and capture photos 606. As indicated by step 750, the field service contractor manager reviews the documentation compiled by the mobile app users/field contractor crew. According to one example, the field service contractor may require additional input and/or comments from the field service crew, and the documentation could be sent back to the field service crew by the field service manager. In other words, steps 740 and 750 could be part of an iterative process.

As indicated by step 760, the revised or updated bid is submitted to the field service company or a real estate broker 724 for review or payment. As indicated by step 770, the field service company or a real estate broker 724 compares the received property file/bid 622 (shown in FIG. 17) against the independently researched pricing 624. Because interface 530 drives a standardized hierarchical scripted questionnaire for the input of information pertaining to line items 604, interface 530 ensures that the contractor bid price 622 for a particular line item includes all of the same tasks as those tasks upon which an independently researched price 624 is based. In other words, interface 530 ensures that the comparisons of line items are for line items containing the exact same group of tasks.

As indicated by step 770, such jobs or action items may be accepted or rejected on a per line item basis or may be accepted as a whole or on a per line item basis. Bids exceeding the allowable total for a property may be submitted to the asset owner for further review. In one example, administration of this rule is automated; in another example, this may be manual. As indicated by step 780, in some implementations, asset owner may review a new bid as well and compare it to the independently researched pricing 624, wherein jobs may be accepted or rejected on a line item basis.

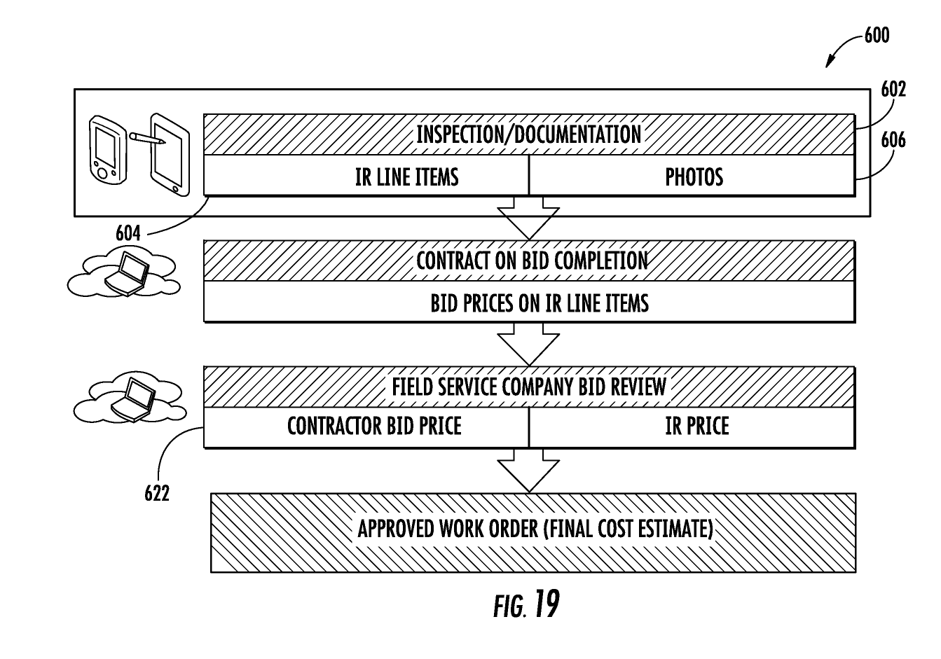

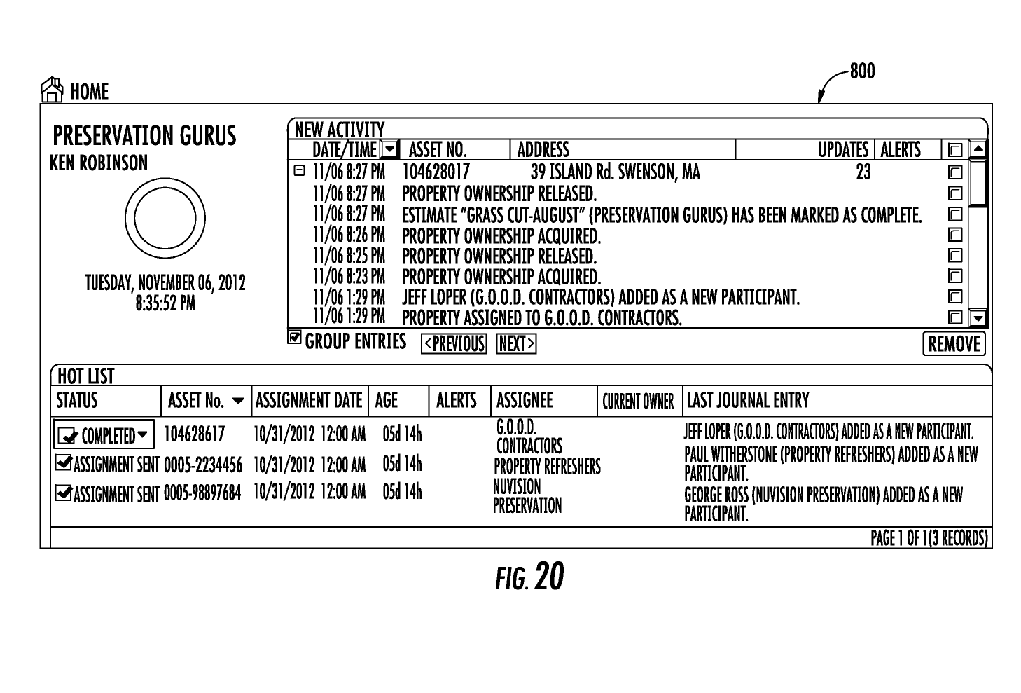

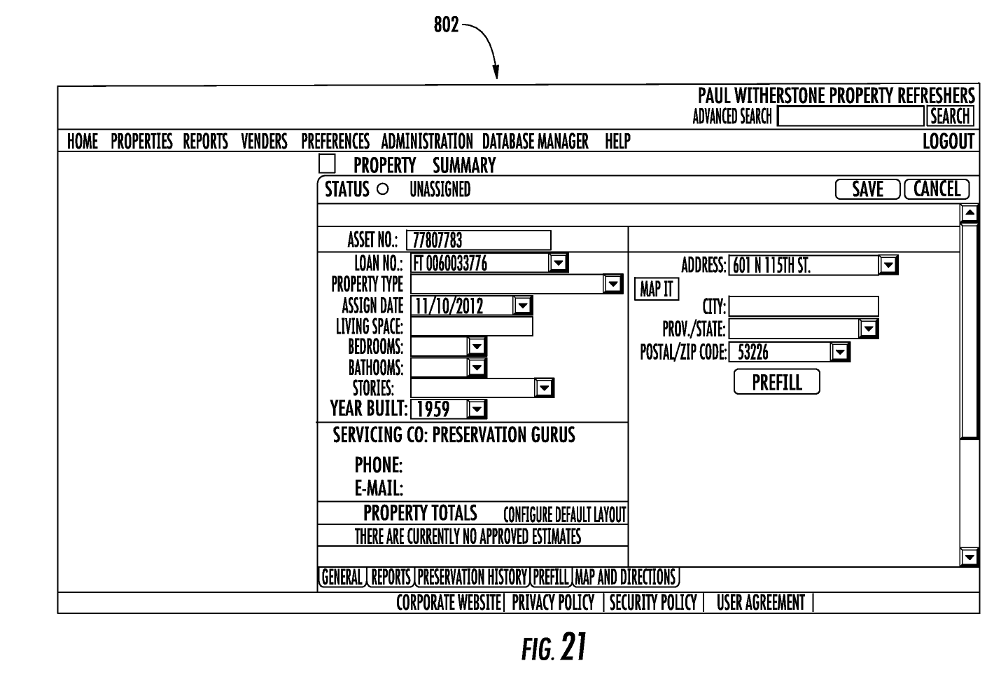

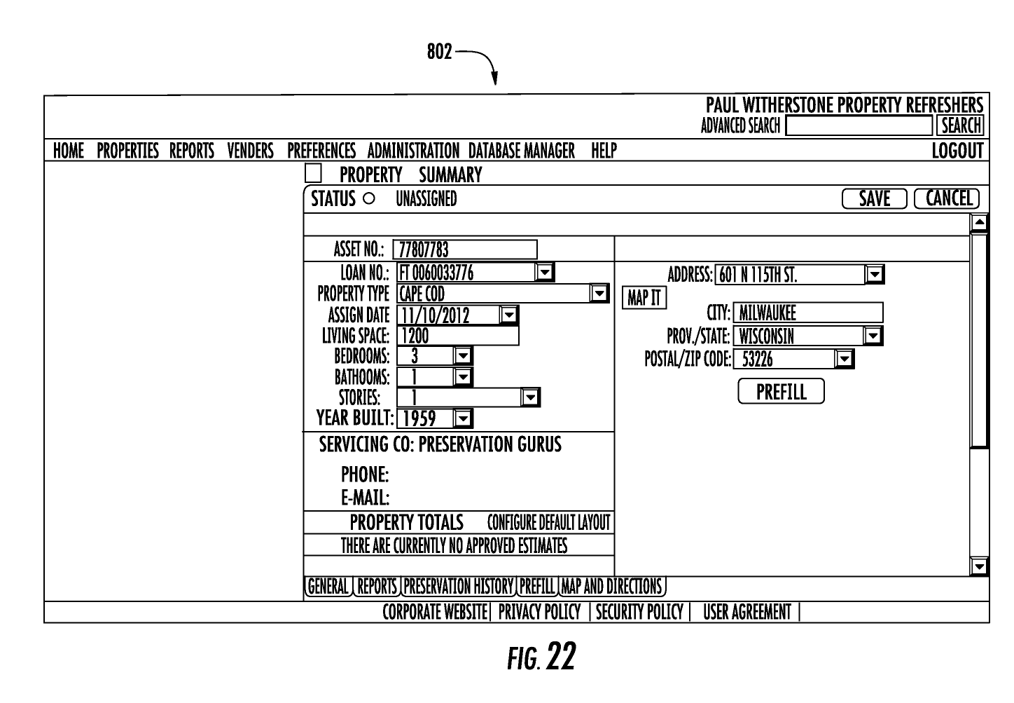

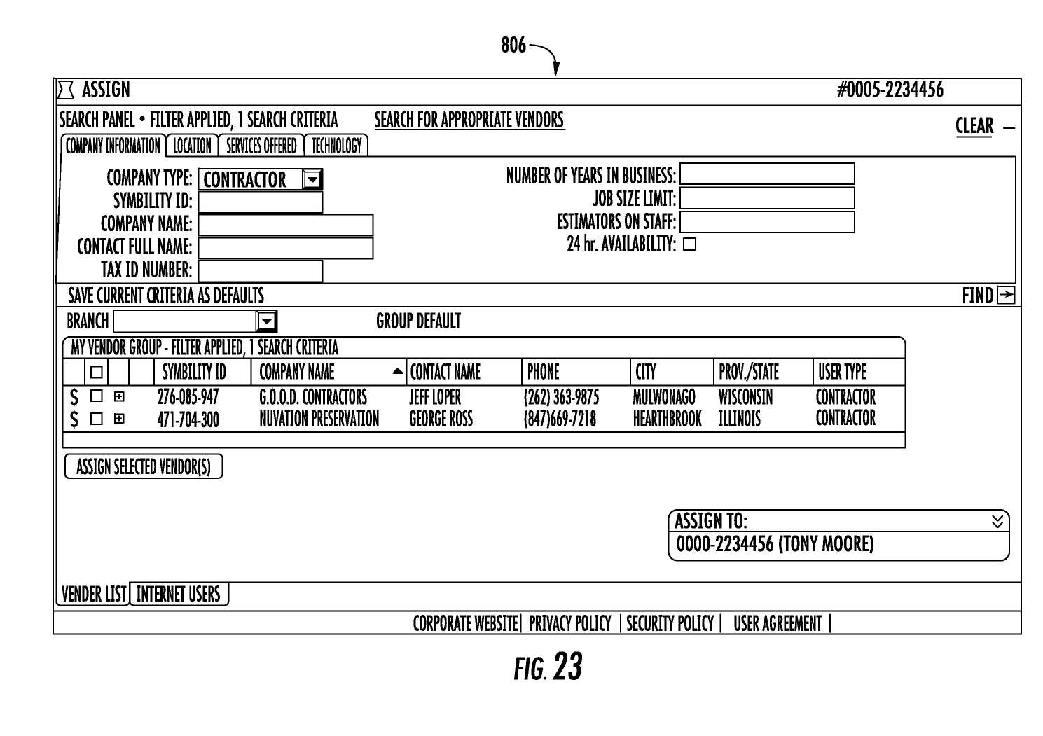

FIG. 19 is a flow diagram of an example process 600 that may be carried out by interface 530. FIGS. 20-35 illustrate one example of a portion of interface 530 for carrying out step 602 of process 600. As shown by FIG. 19, step 602 (corresponding to step 720, 730, 740 and 750 in method 700) involves the gathering of information such as information for line items 604 and photos 606. FIG. 20 illustrates an example dashboard 800 of interface 530 that may be accessed by a field service company (Preservation Gurus in the example) (an example of one of users 528 in FIG. 16). Dashboard 800 provides the field service company with the ability to view details on properties for which the field service company is responsible. FIG. 21 illustrates an example interface screen 802 which may be accessed by the field service company using interface 530. Interface screen 802 illustrates how the field service company may create a new file for a particular assigned property. FIG. 22 illustrates an example screen shot or interface screen 804 which depicts how property data may be prefilled. In one example, interface 530 may consult business partners are external data sources to obtain information for such property and to automatically fill in data items in the file for the newly created property file. As noted above, in some implementations, such data may be obtained from governmental data sources. Other information may be attained from private data sources. In the example illustrated, the number of bedrooms and living space (square footage) may be estimated from a combination of aerial photographs, knowledge table predictives or graphic information. FIG. 23 illustrates an example interface screen 806 which is accessed by the field service company/real estate broker using interface 530 to assign field service contractors to the particular property. Interface 530 facilitates searching of a database of past or potential field service contractors when making such assignments. The search panel up atop provides several options or categories (location, services offered, technology) by which to find or search for contractors for particular job assignments.

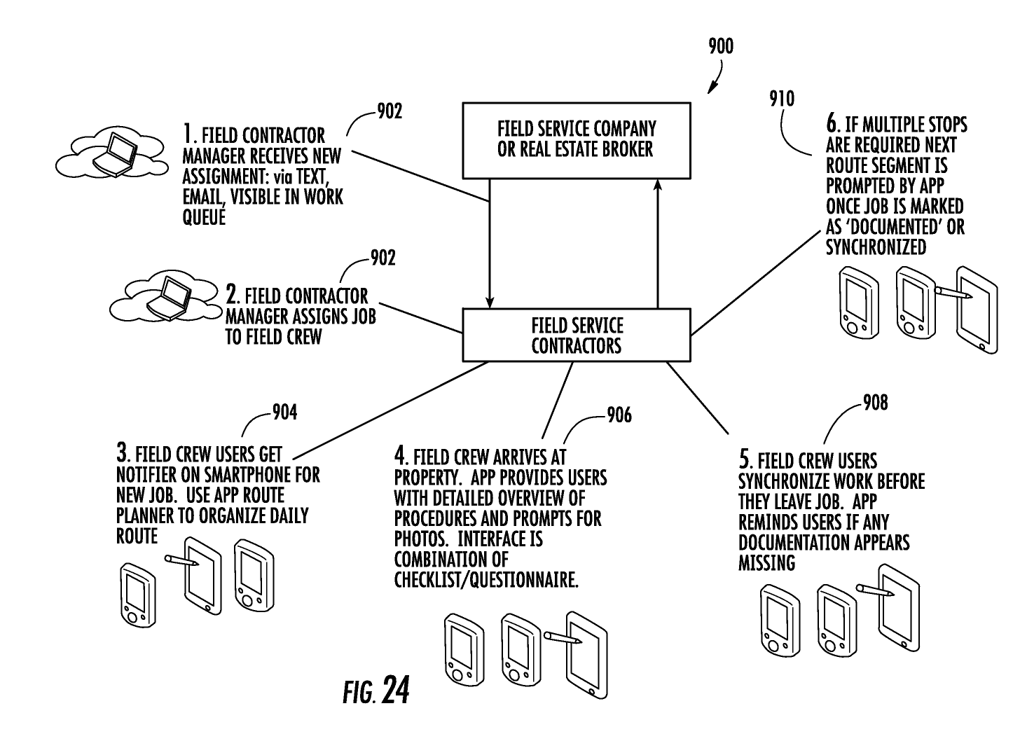

FIG. 24 illustrates an example contractor workflow process 900 using interface 530. As indicated by step 902, a field contract manager receives a new assignment via a text or e-mail generated by interface 530 automatically based upon a contractor assignment made in interface screen 806 of FIG. 23. Alternatively, such assignment may be personally made outside of interface 530 or through another communication portal through interface 530.

As indicated by step 902, the field contract manager assigns a job (responsibility for inspecting a particular property and preparing a bid) to a field crew. As indicated by step 904, field crew receives the notifier on a portable electronic device, such as a smart phone and uses a route planner provided through interface 530 (or another source) to organize a daily or weekly route. As indicated by step 906, the field crew arrives at the property, wherein application interface 530 provides the crew members with the hierarchical modifiable scripted questionnaire which prompts the crew through the gathering of information. Each crew member may be specialized or dedicated to a particular inspection task regarding the property. As indicated by step 908, if the crew includes multiple crewmembers, their work is synchronized by interface 530. Interface 530 reminds individual crew members or users if any particular documentation or information has been omitted. As indicated by step 910, once a particular job has been marked as documented or synchronized, the crews are prompted to the next route segment our next job.

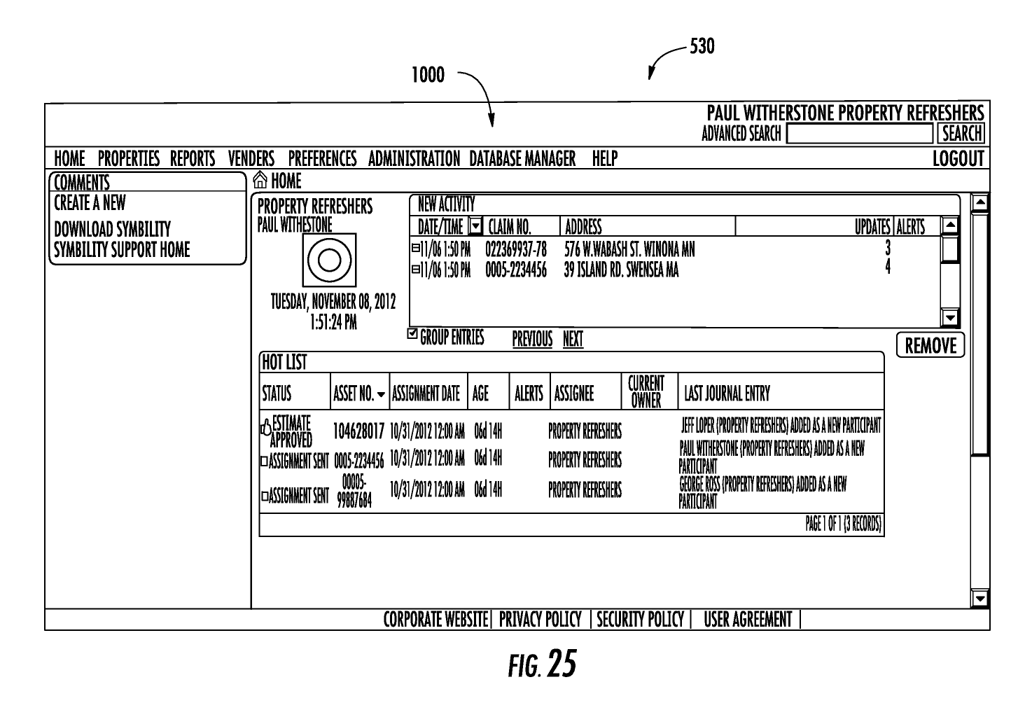

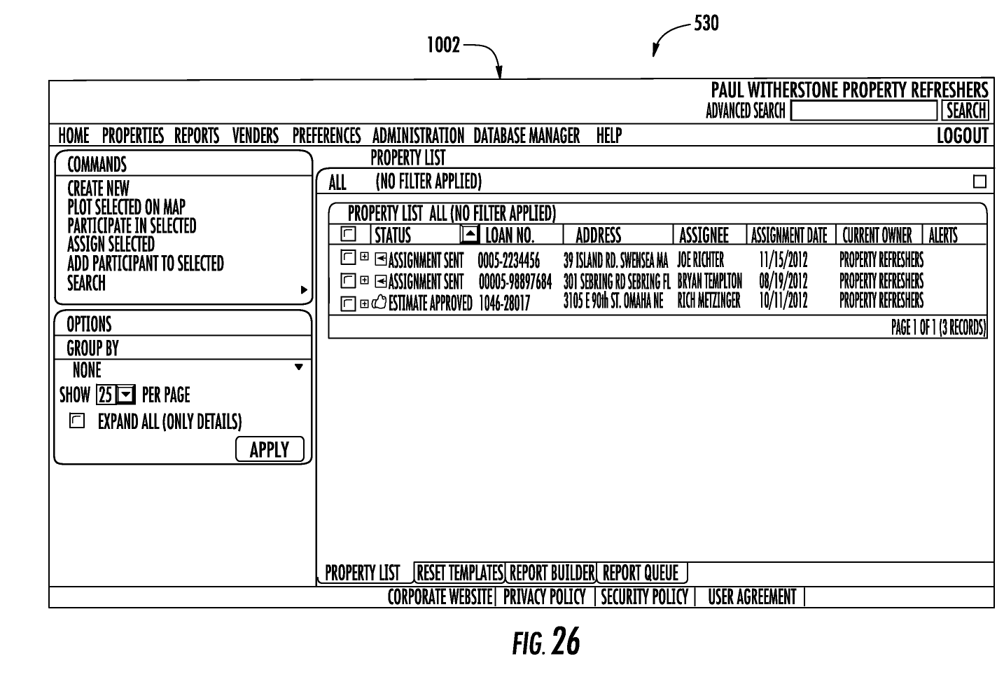

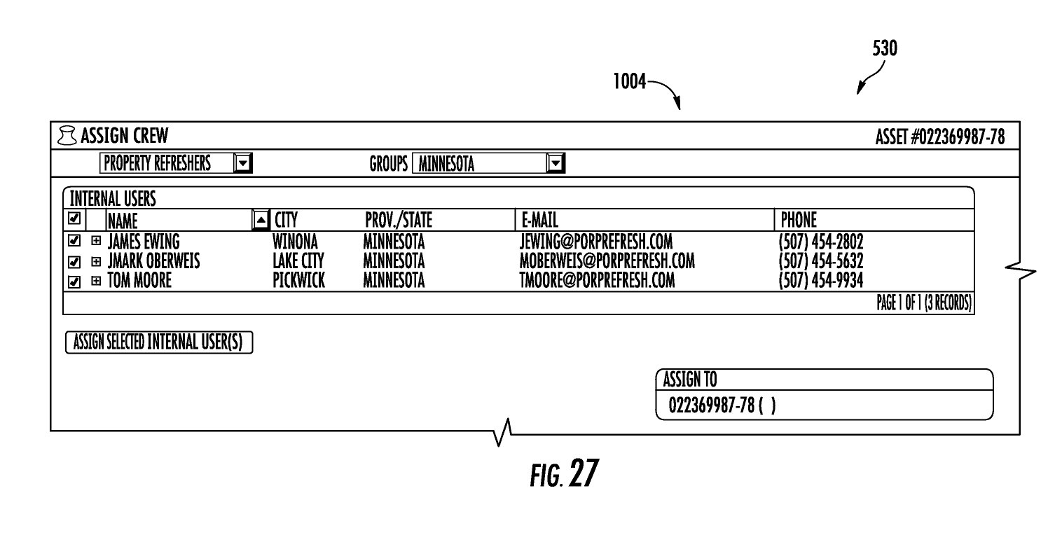

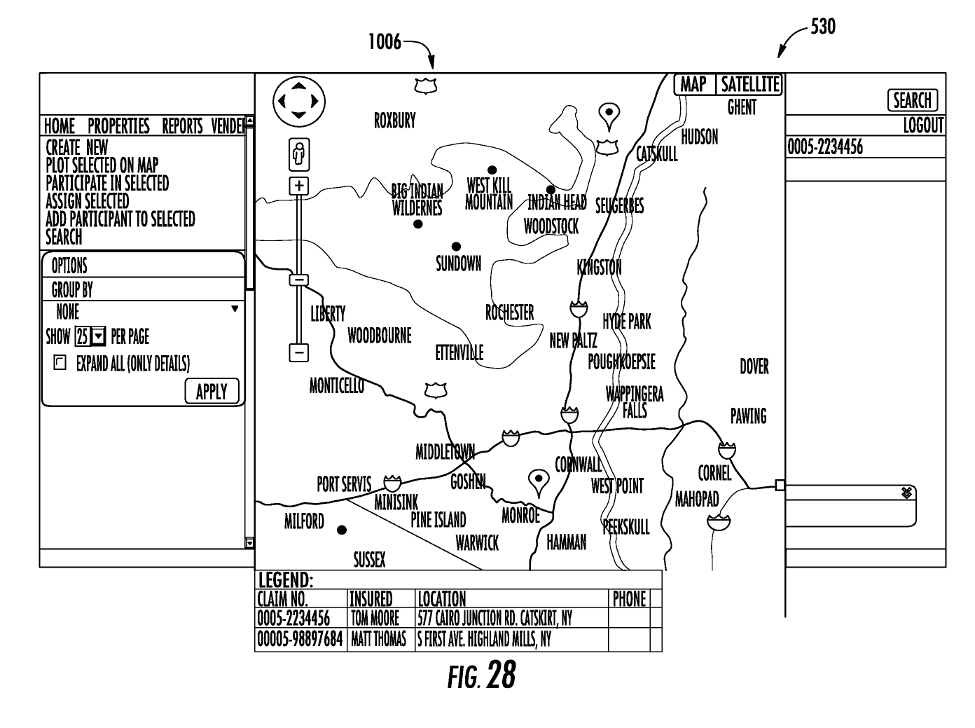

FIG. 25 illustrates an example interface screen or dashboard 1000 which may be accessed by a field service contractor manager. Dashboard 1000 is similar to dashboard 800 used by the field service company except that dashboard 1000 identifies properties or jobs that have been assigned to the field service contractor. FIG. 26 illustrates an example interface screen 1002 accessible by the field service contractor listing each property that has been assigned and a crew assignment status for each property. FIG. 27 illustrates an example interface screen 1004 (provided by interface 530) which facilitates the assignment of crewmembers to particular jobs. FIG. 28 illustrates an example interface screen 1006 presented by interface 530 and accessible by a field service contractor providing a map route for different jobs for a crew.

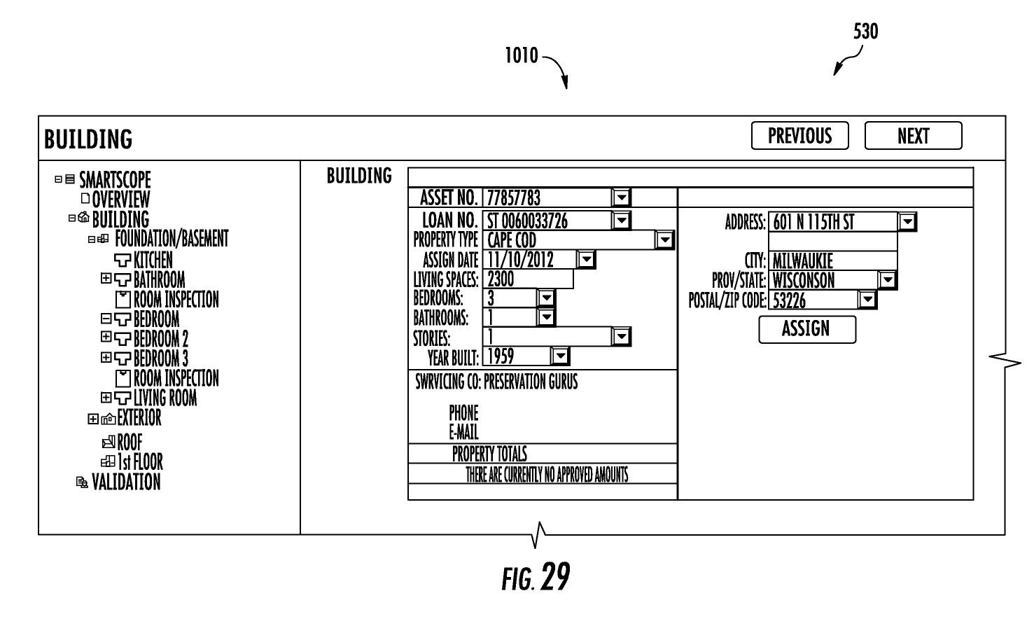

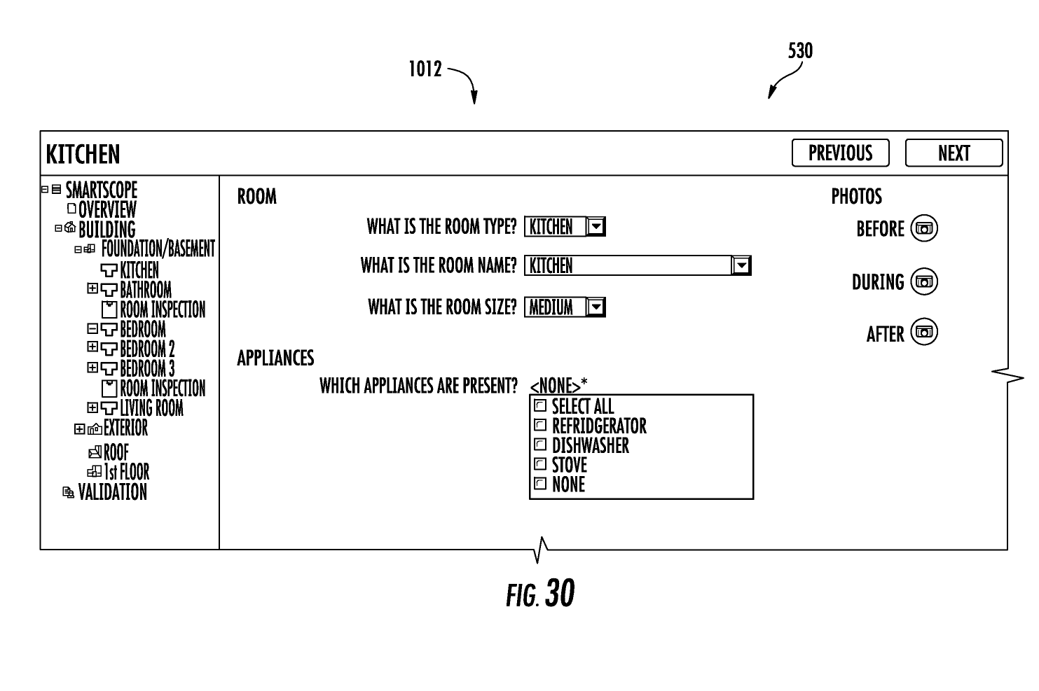

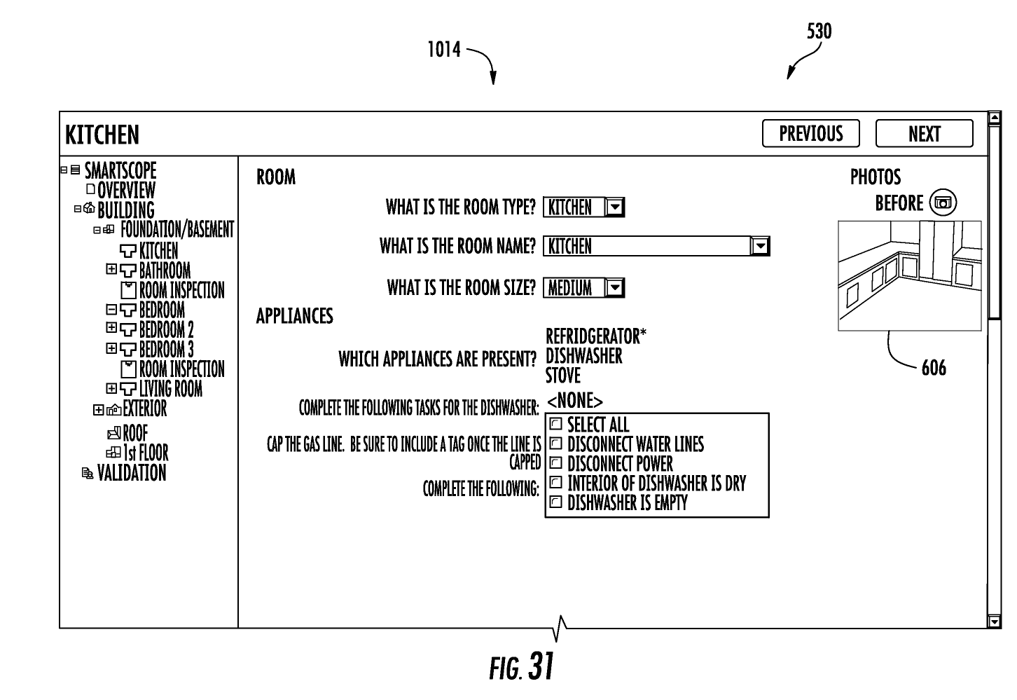

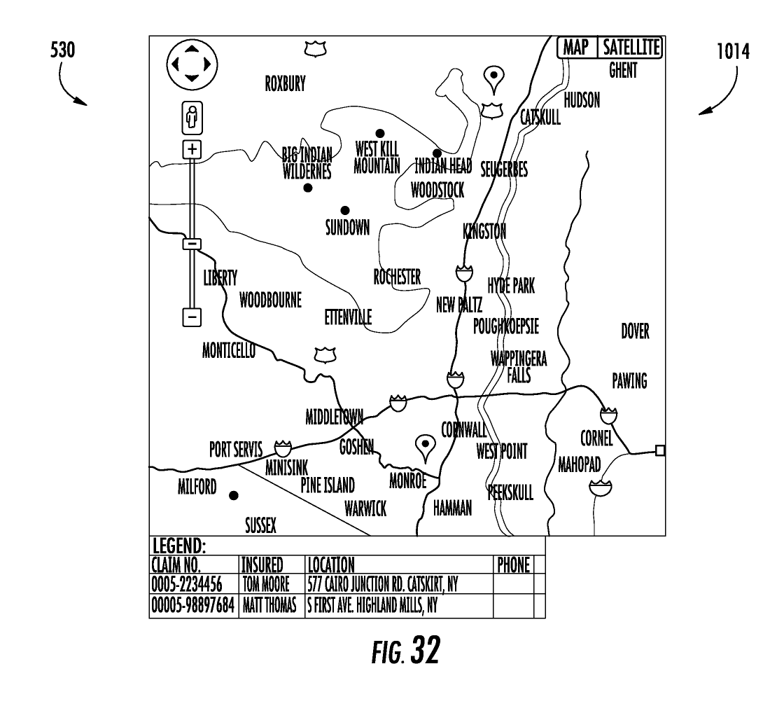

FIGS. 29-35 illustrate exemplary portions of interface 530 on mobile devices of field crew. FIG. 29 illustrates an example screen interface 1010 provided by interface 530. Interface 1010, accessed by the field service crew, provides a field service crew with information regarding a job, including prefilled information (as discussed above). FIG. 30 illustrates an example screen interface 1012 provided by interface 530. Interface 1012 presents the field crew member with the hierarchical modifiable scripted questionnaire during inspection. In the example illustrated the crew workers are prompted to input what type of room is being inspected, its size and what appliances are present. As shown by FIG. 31, which illustrates a follow-up screen interface 1014, based upon such answers, the crewmember is prompted to input additional information based upon input received in interface 1012. Example photo 606 is further prompted for input. As shown by FIG. 32, interface 530 provides an interface screen 1014 presenting the crewmember with a route map for the next stop once the prior property inspection has been completed.

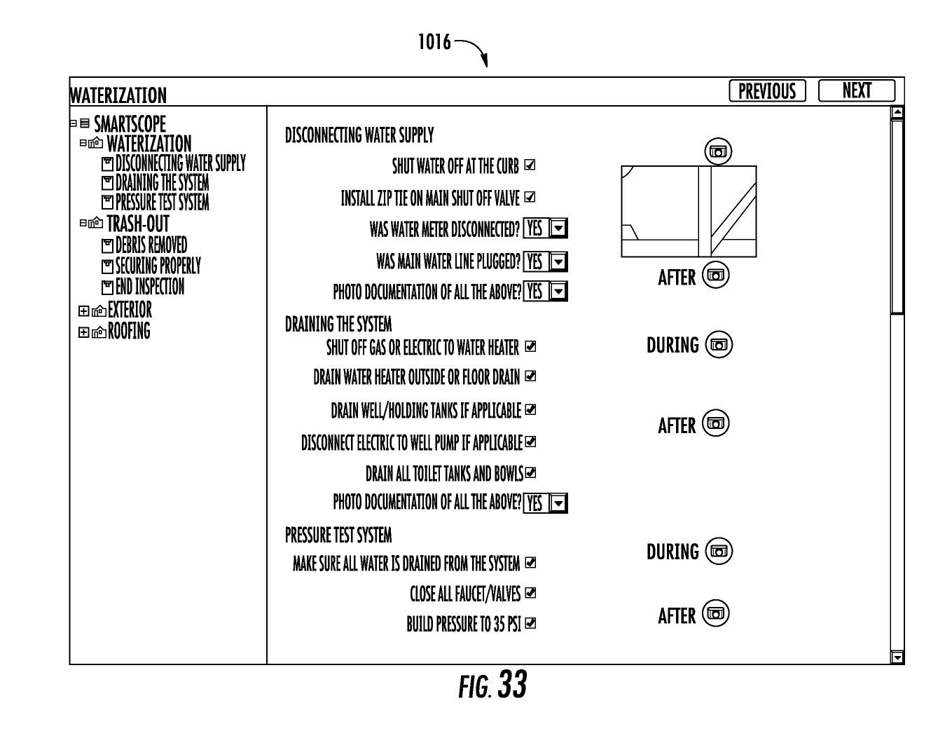

Later on, once a bid has been approved by the field service company or asset owner, interface 530 may additionally assist the field crew (or other entity performing the actual repair or preservation task) in executing and documenting the job. FIG. 33 illustrates an example screen interface 1016 which may be accessed by the working field crew on portable electronic devices or smart phones through interface 530. Screen interface 1016 prompts the working crew through each of the tasks that made up the line items of the bid job which is being executed. Interface 530 further prompts the work crew to input photographs first, of the work being completed and second, after the work has been completed.

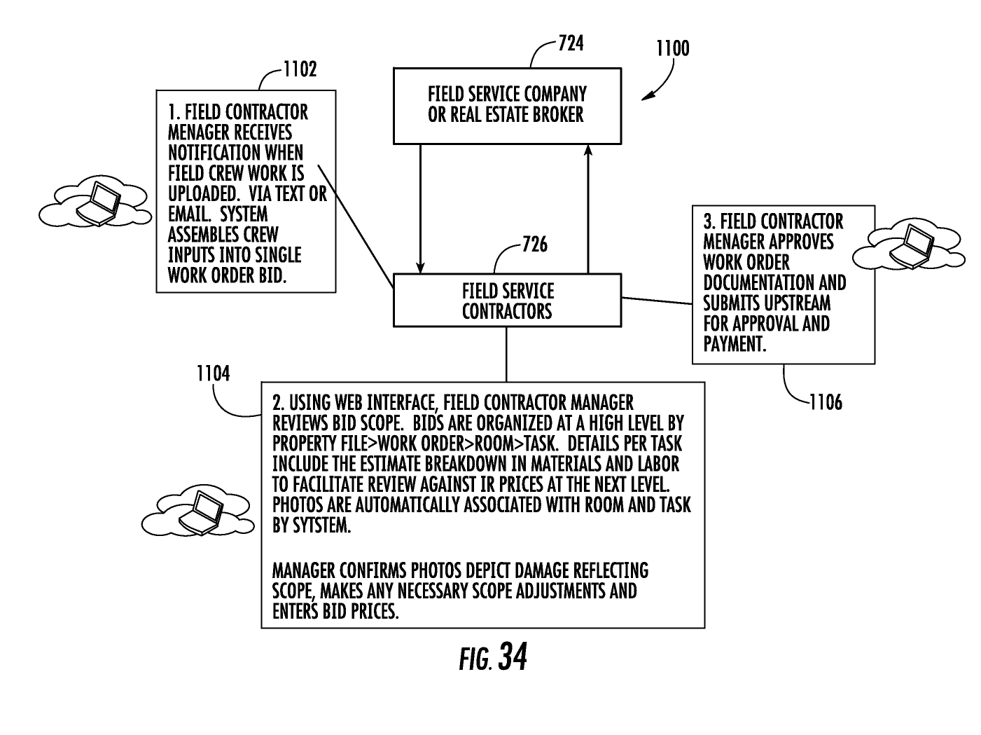

FIGS. 34-36 illustrate example methods of using interface 530 to carry out the contractor bid completion step 610 of method 600 (corresponding to steps 4 and 5 of method 700) as shown in FIG. 17. FIG. 34 is a flow diagram illustrating an example workflow for step 610 shown in FIG. 17. As indicated by step 1102, the field contractor manager receives notification when the inspection work of the field crew has been completed per step 602 and has been up uploaded. This notification may be automatically generated by interface 530. Alternatively, such notification may be made personally or directly by the field contractor manager or through other communication avenues. As indicated by step 1104, using interface 530, the field contractor manager reviews the bid scope to ensure that details are sufficient for adequate comparison with the independently regulated prices by the field service company. As indicated by step 1106, the field service contractor manager approves the documentation and submits it upstream to the field service company (again using interface 530).

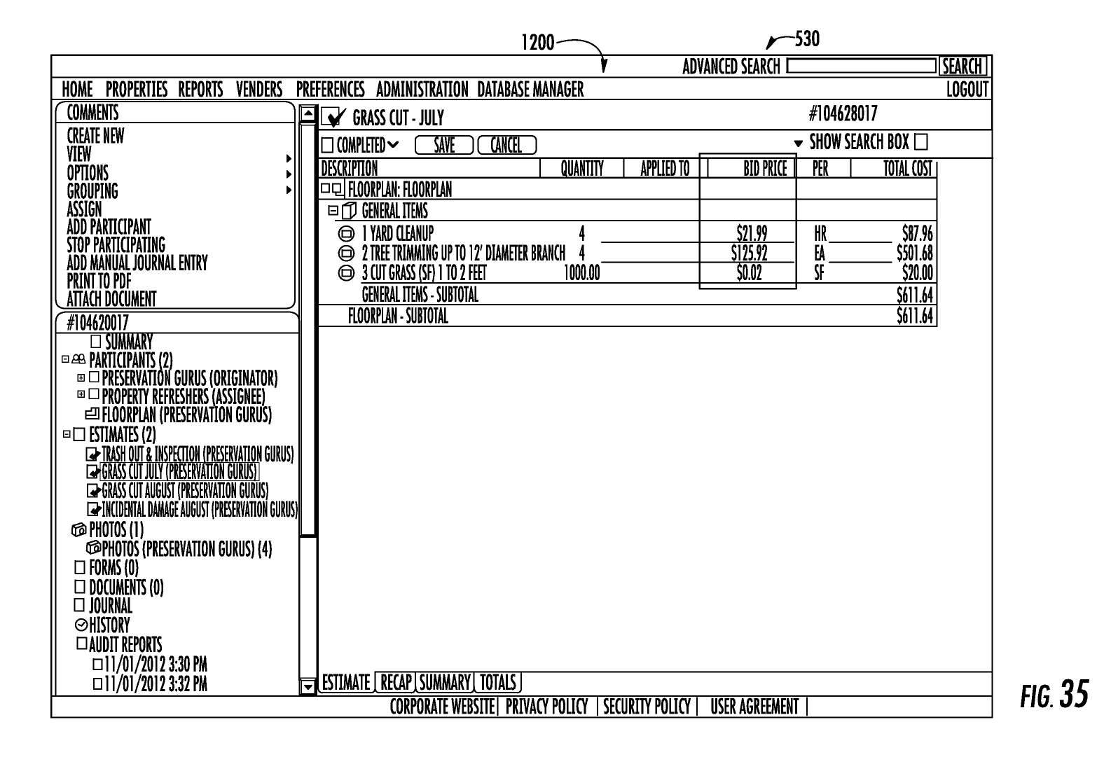

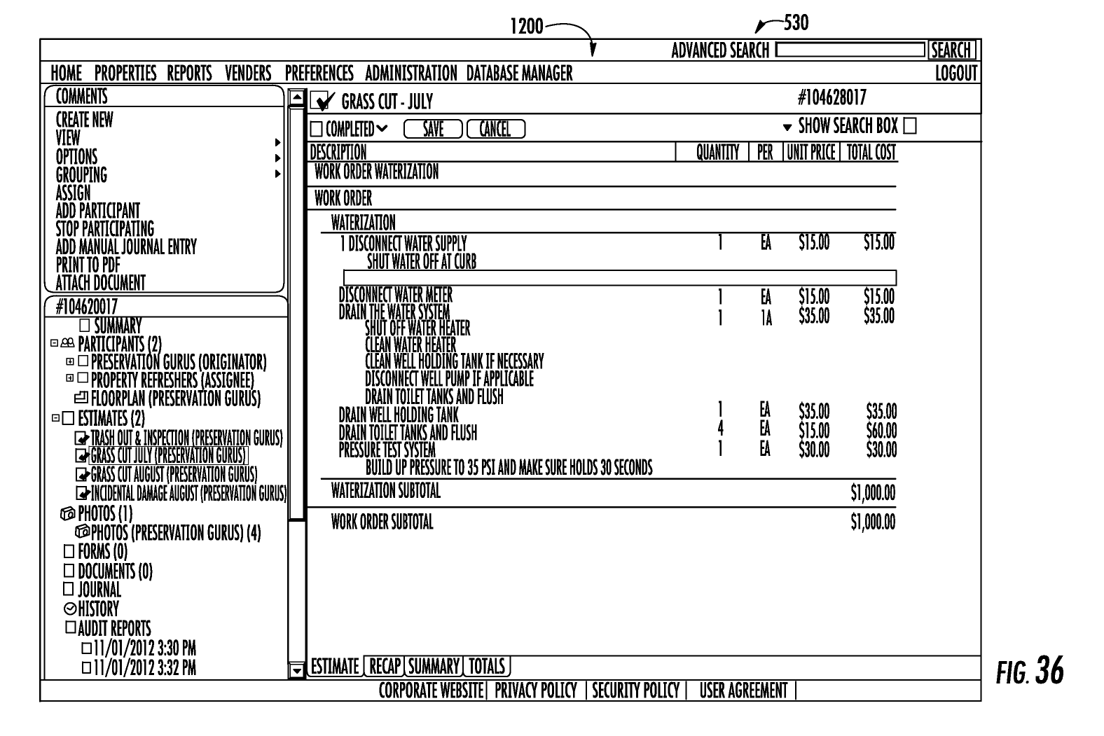

FIG. 35 illustrates an example interface screen 1200, provided by interface 530 and used by the field service contractor manager to review information generated based upon field crew input and review of the bid. FIG. 36 illustrates screen interface 1202, an example interface provided by interface 530 which depicts the bid or estimate as a whole for review.

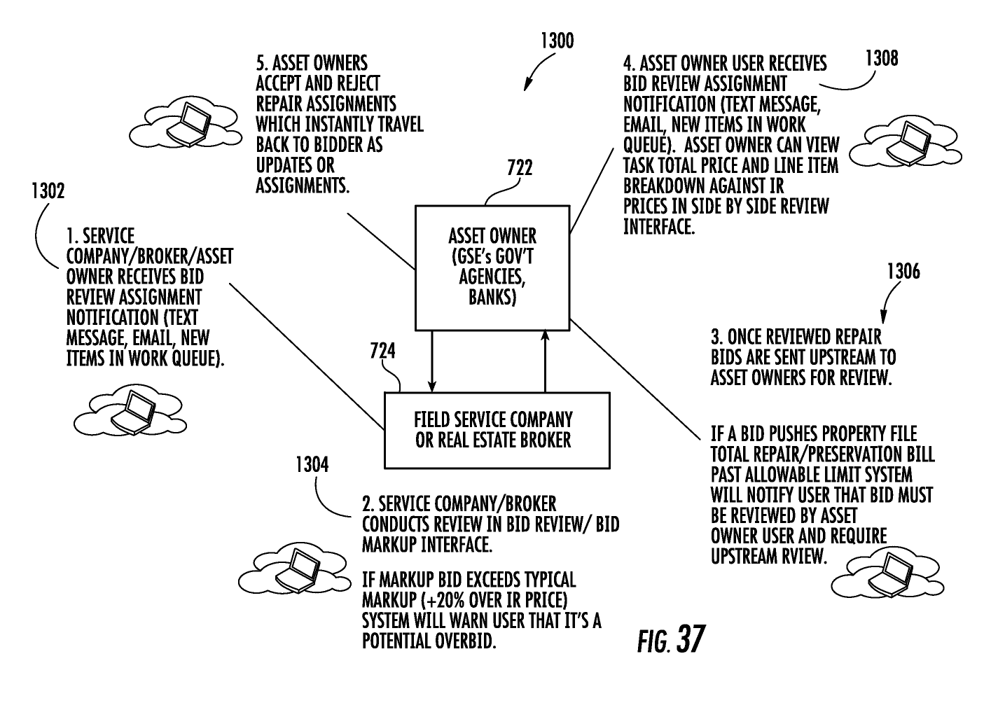

FIGS. 37-44 illustrate one example method of using interface 530 to carry out the field service company bid review step 620 of method 600 (corresponding to step 6 and/or step 7 of method 700) as shown in FIG. 17. FIG. 37 is a flow diagram illustrating an example workflow 1300 for step 620 of FIG. 17. As indicated by step 1302, the service company/real estate broker 724 and/or asset owner 722 receives a bid review assignment notification from the field service contractor. This notification is automatically generated by interface 530 upon receiving an upload completed bid from the field service contractor via interface 530. Alternatively, the notification may be personally sent to the field service company 724 or may be communicated along other communication avenues.

As indicated by step 1304, the field service company reviews a bid and compares a bid to the independently researched prices 624. As noted above, because the bids have been generated using the scripted questionnaire provided by interface 530, the field service company may be assured that the line item estimates for the bid have the same underlying factual basis as the independently researched estimates for the corresponding line items.

As indicated by step 1306, the reviewed bids are set up stream to an asset owner for approval. As indicated by step 1308, the asset owner receives bid review assignment notification. This notification may be automatically generated by interface 530 in response to receiving the bid from the service company through the interface 530. The asset owner may further compare the bid line item estimates with independently researched line item estimates.

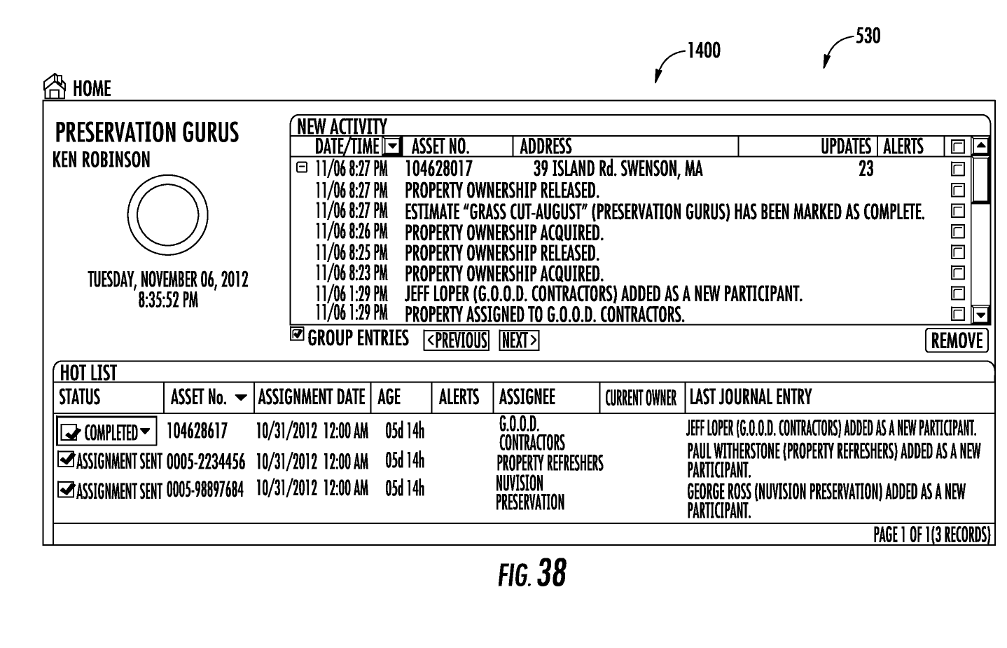

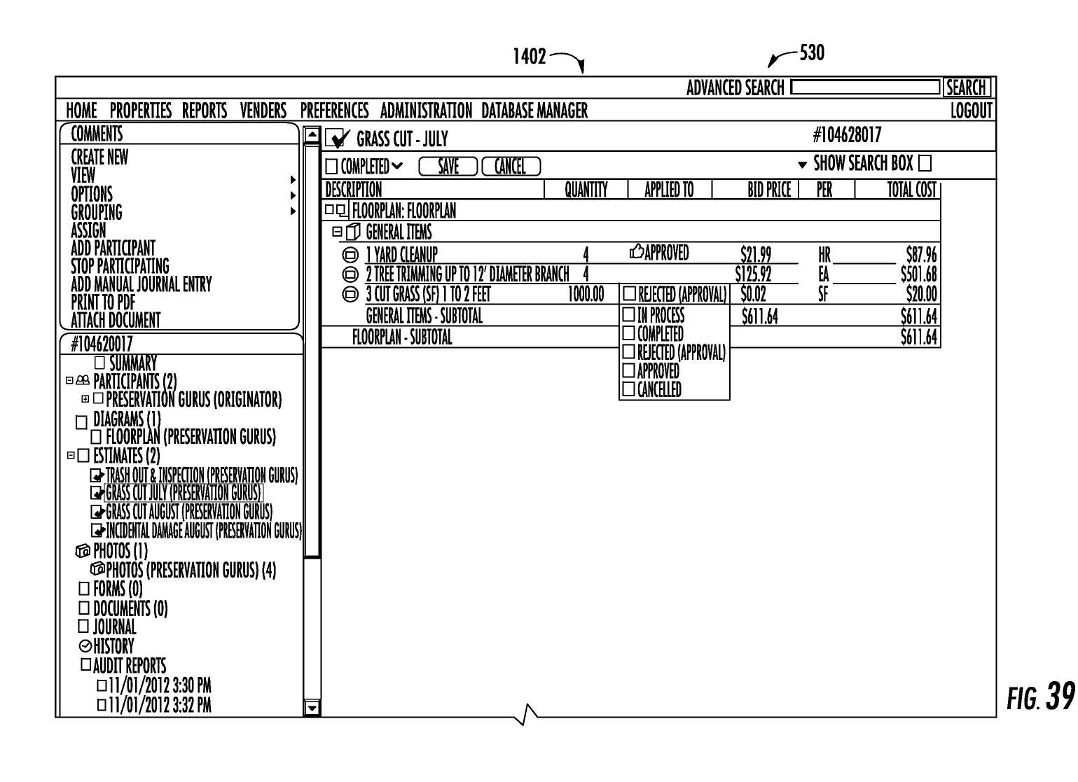

FIG. 38 illustrates an example dashboard or screen interface 1400 that may be provided by interface 530 to the field service company upon being accessed by the field service company. Screen interface 1400 is identical to screen interface 800 shown in FIG. 20, identifying the status of properties with respective field service contractors. Screen interface 1400 may be accessed to identify which field service contractor bids have been received. FIG. 39 illustrates an example screen interface 1402 provide by interface 530 to the field service company. As shown by FIG. 39, interface 530 automatically retrieves the independently researched cost estimates for each of the line items presented in the field service contractor bid using the information provided by the field service field crew received through interface 530. The independently researched cost estimates are presented side by side with the field service contractor bid, allowing the field service company to directly compare the line items of the field service contractor bid with the independently researched estimates for each of the same line items. As a result, the field service company avoids the task of having to reenter data from the field service contractor bid to generate the independently researched cost estimate for comparison. Moreover, the field service company may be assured that each of the appropriate pieces of information entered through interface 530 by the field crew at the property site and used as a basis for generating the field service contractor bid is also being used as a basis for the displayed independently researched cost estimate. In simple terms, interface 530 ensures the field service company of an accurate comparison between the field service contractor bid line items in the independently researched line item cost estimates.

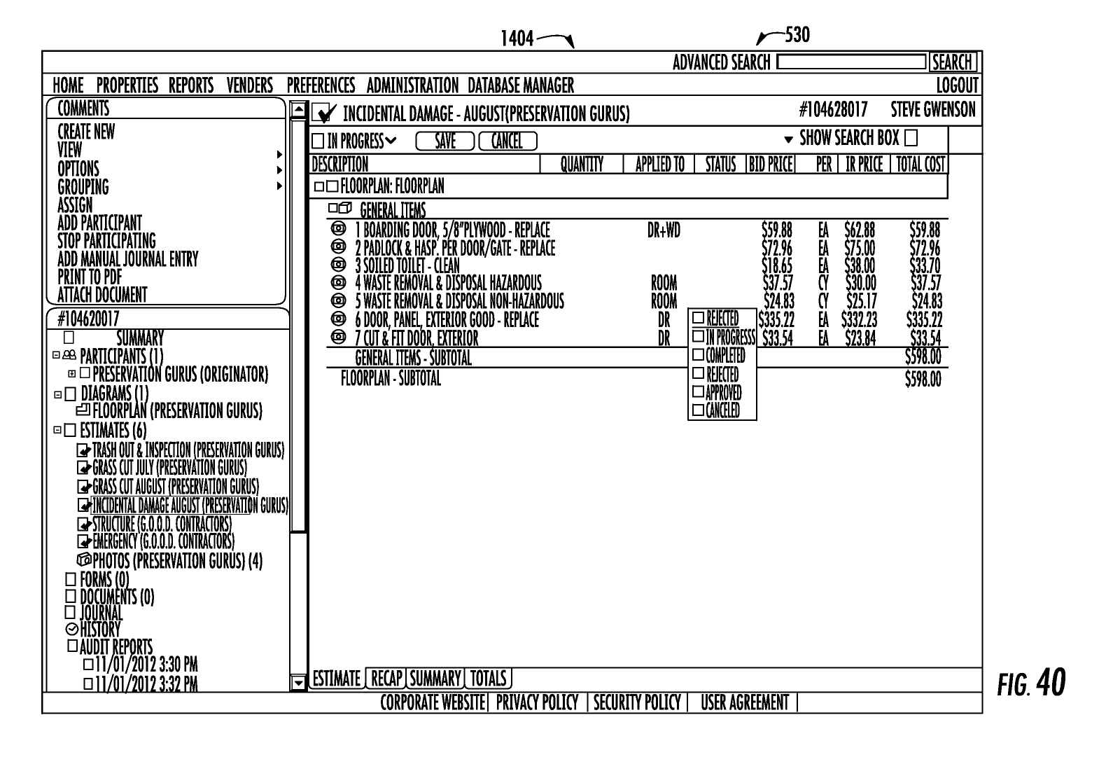

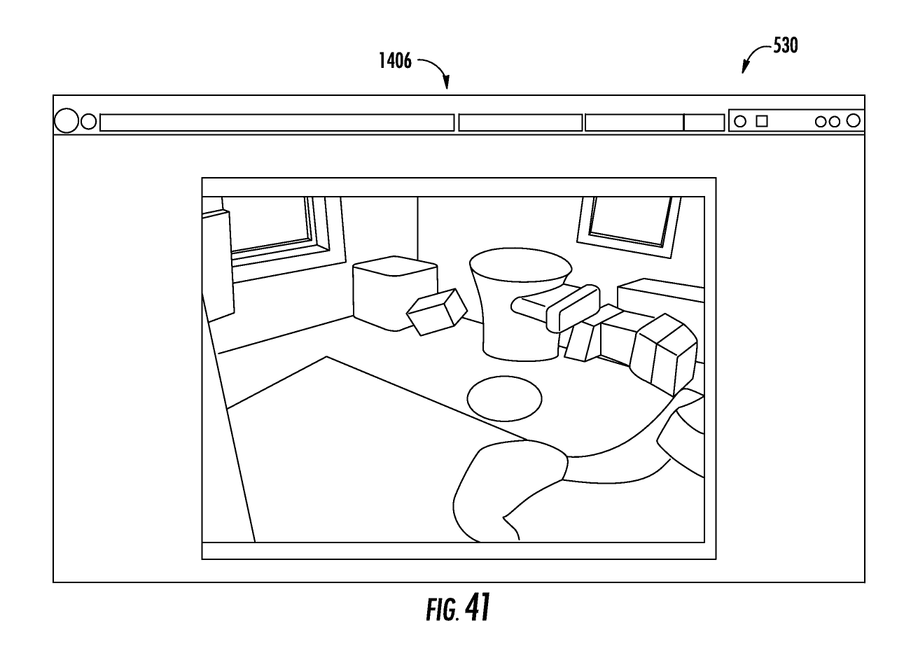

FIG. 40 illustrates an example screen interface 1404 illustrating another example display provided by interface 530 to the field service company to allow the field service company to compare the field service contractor bid line item costs with the independently researched line item cost estimates. As shown by FIG. 41, interface 530 further enables the field service company to review the underlying data serving as a foundation for the field service contractor bid. In particular, shown by FIG. 41, interface 530 provides a screen interface 1406, allowing a field service company to review the inspection photos taken by the field service group to verify that need for the various line item tasks.

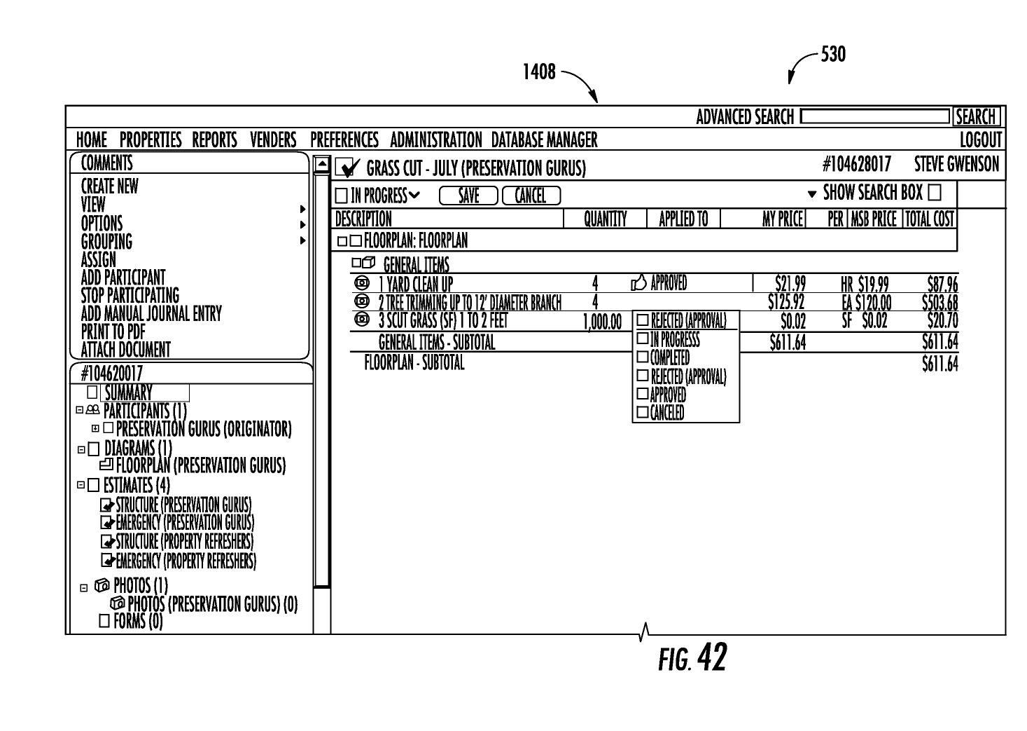

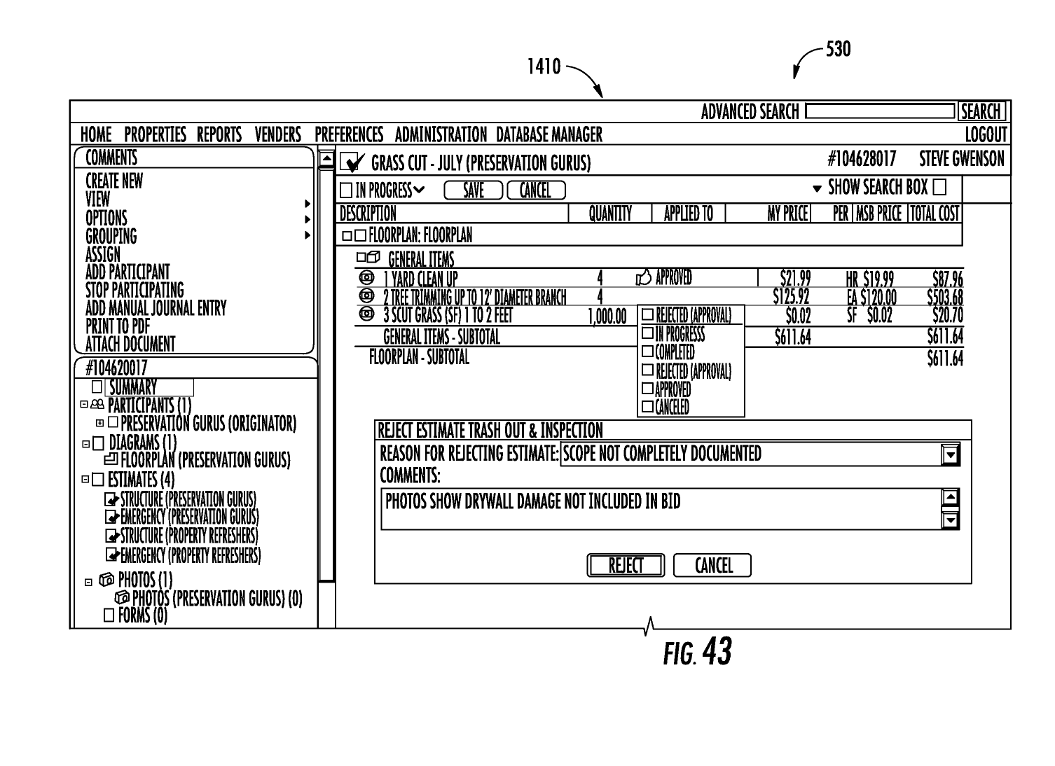

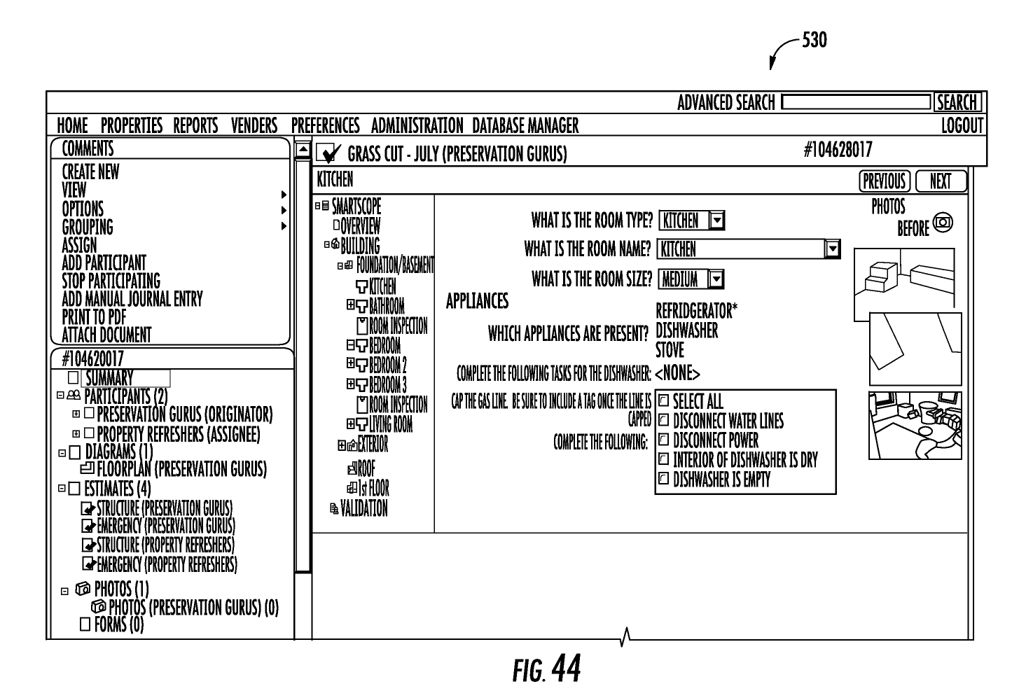

As shown by FIG. 42, interface 530 generates screen interface 1408 and provides menu items or pop-ups allowing the field service company to approve or reject the field service contractor bid. As shown by FIG. 43, in the case that a bid is rejected either in whole or in part, interface 530 generates screen interface 1410 prompting the field service company to indicate reasons for the rejection. Such reasons may be automatically transmitted to the field service contractor upon receiving authorization and finalization from the field service company. As shown by FIG. 44, interface 530 may additionally facilitate the creation of comparative bids.

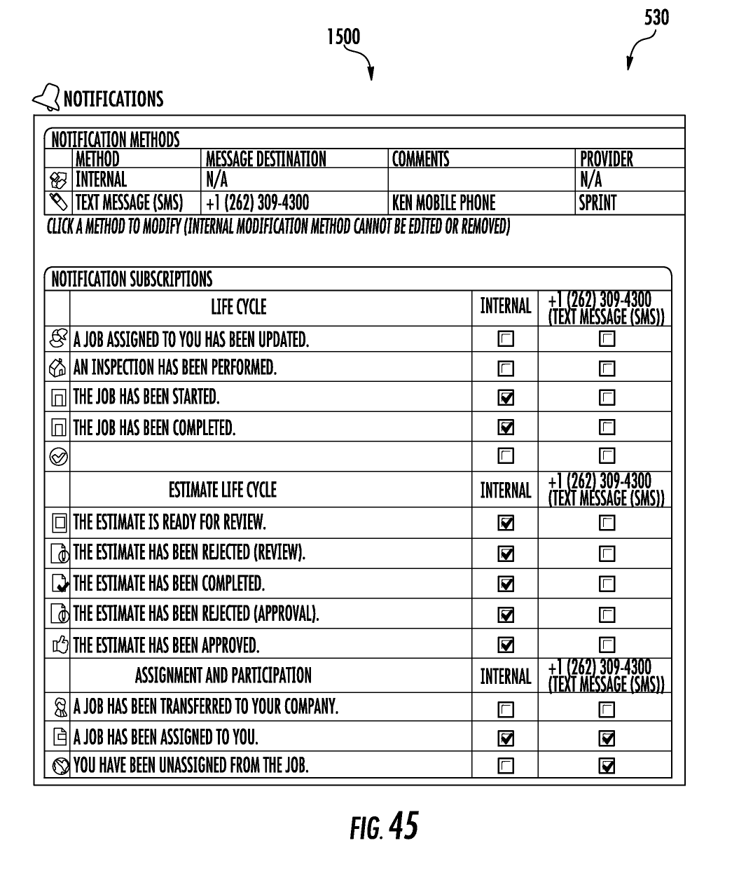

FIG. 45 illustrates an example screen interface 1500 that may be presented by interface 530 to the user 528. As shown by screen interface 1500, the user 528 (such as the field service contractor, field service contractor crew or field service company) may define as to how and when notifications are to be automatically generated by interface 530 and transmitted.

Although the present disclosure has been described with reference to example embodiments, workers skilled in the art will recognize that changes may be made in form and detail without departing from the spirit and scope of the defined subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A method comprising:
receiving a graphic of a property;
determining a characteristic of the property from the received graphic;
modifying a modifiable hierarchical scripted questionnaire based on the characteristic of the property determined based upon the received graphic;
displaying the questionnaire as modified based on the characteristic of the property determined from the received graphic; and
displaying an estimate pertaining to the property based on the graphic and responses to the questionnaire, as modified.

2. The method of claim 1, wherein the property comprises a building and wherein the received graphic comprises a floor diagram.

3. The method of claim 1, wherein received graphic comprises a captured image of the property.

4. The method of claim 3, wherein the property comprises a building and wherein the received graphic comprises a captured overhead image of a roof of the building.

5. The method of claim 1, wherein modifying the questionnaire comprises removing questions from the questionnaire.

6. The method of claim 1, wherein the questionnaire is presented on a portable electronic device and wherein the method further comprises transmitting the estimate to a central server of an insurance entity.

7. An apparatus comprising:
a non-transient computer-readable medium containing software to direct processing unit to:
receive a graphic of the property;
determine a characteristic of the property from the received graphic;
modify a modifiable hierarchical scripted questionnaire based on the characteristic of the property determined based upon the received graphic;
display the questionnaire as modified, based on the characteristic of the property determined from the received graphic; and
display an estimate pertaining to the property based on the graphic and the responses to the questionnaire.

8. The apparatus of claim 7 wherein the property comprises a building and wherein the received graphic comprises a graphic selected from a group of graphics consisting of a floor diagram, a vector diagram, a wire frame and the like.

9. The apparatus of claim 7 wherein the received graphic comprises a captured image of the property.

10. The apparatus of claim 9, wherein the property comprises a building and wherein the received graphic comprises a captured overhead image of a roof of the building.

11. The apparatus of claim 9, wherein the software directs the processing unit to remove questions from the questionnaire.

12. The apparatus of claim 9, wherein the software directs the processing unit to:
present the questionnaire on a portable electronic device; and
transmit the estimate to a central server of an insurance entity.

13. A method comprising:
presenting a modifiable hierarchical scripted questionnaire regarding a characteristic of an unoccupied building;
receiving responses to the questionnaire;
modifying the questionnaire based upon the received responses; and
displaying maintenance and/or repair and protection steps for the unoccupied building based on the responses to the questionnaire as modified.

14. The method of claim 13 further comprising:
receiving a graphic of at least a portion of the unoccupied building;
determining a characteristic of the unoccupied building based on the graphic; and
modifying the modifiable hierarchical scripted questionnaire based on the characteristic of the property determined based upon the received graphic.

15. The method of claim 14, wherein the property comprises a building and wherein the received graphic comprises a flow diagram.

16. The method of claim 14, wherein the received graphic comprises a captured image of the property.

17. The method of claim 16, wherein the property comprises a building and wherein the received graphic comprises a captured overhead image of a roof of the building.

18. The method of claim 1, wherein modifying the questionnaire comprises removing questions from the questionnaire.

19. The method of claim 13, wherein the questionnaire prompts for a response regarding the existence of an appliance and wherein the displaying of maintenance steps comprises displaying a recommended capping of a water or energy supply to the appliance or similar.

20. An apparatus comprising:
a non-transient computer-readable medium containing software to direct processing unit to:
present a modifiable hierarchical scripted questionnaire regarding a characteristic of an unoccupied building;
receive responses to the questionnaire;
modify the questionnaire based upon the received responses; and
display maintenance steps for the unoccupied building based on the responses to the questionnaire, as modified.
